(19) United States
(12) Patent Application Publication
(10) Pub. No.: US 2025/0265985 A1
(43) Pub. Date: Aug. 21, 2025

(54) LIGHT EMITTING APPARATUS, WEARABLE DEVICE, DISPLAY APPARATUS, PHOTOELECTRIC CONVERSION APPARATUS, ELECTRONIC DEVICE, ILLUMINATION APPARATUS, AND MOVING BODY

(71) Applicant: CANON KABUSHIKI KAISHA, Tokyo (JP)

(72) Inventors: DAISUKE KOBAYASHI, Kanagawa (JP); ATSUSHI FURUBAYASHI, Kanagawa (JP)

(21) Appl. No.: 19/046,692

(22) Filed: Feb. 6, 2025

(30) Foreign Application Priority Data
Feb. 15, 2024 (JP) 2024-021450

(51) Int. Cl. G09G 3/3225; H04N 23/53

(52) U.S. Cl. CPC G09G 3/3225; G09G 2310/027; G09G 2310/0291; G09G 2320/02; G09G 2330/028; G09G 2360/145; H04N 23/53

(57) ABSTRACT

The present invention provides a light emitting apparatus comprising: a plurality of light emitting devices; a plurality of conversion circuits provided in correspondence with the plurality of light emitting devices, respectively; and a voltage generator configured to generate a plurality of reference voltages, wherein each of the plurality of conversion circuits converts, using the plurality of reference voltages generated by the voltage generator, a digital signal supplied from an outside into an analog signal for driving one corresponding light emitting device of the plurality of light emitting devices, and at least one reference voltage of the plurality of reference voltages is supplied from the voltage generator to each of the plurality of conversion circuits via a buffer circuit.

### BACKGROUND OF THE INVENTION

### Field of the Invention

The present invention relates to a light emitting apparatus, a wearable device, a display apparatus, a photoelectric conversion apparatus, am electronic device, an illumination apparatus, and a moving body.

### Description of the Related Art

A light emitting apparatus including an organic EL device has a configuration in which a pixel portion formed by arranging pixels in a matrix and driving circuits (more specifically, a horizontal driving circuit and a vertical driving circuit) for driving the pixels are integrated. In the light emitting apparatus, sometimes, a digital interface driving circuit is mounted as the horizontal driving circuit and, for example, a reference voltage selection type DA conversion circuit is used as a digital/analog conversion circuit (to be referred to as a “DA conversion circuit” hereinafter) arranged on a column basis in the driving circuit. In the reference voltage selection type DA conversion circuit, a reference voltage is selected by a switch for each tone, thereby converting a light emission signal input as a digital signal into an analog signal. A signal line that transmits the light emission signal converted into the analog signal by the DA conversion circuit to each pixel in the pixel portion has a capacity. The DA conversion circuit performs a charge/discharge operation of the signal line such that the signal line obtains a predetermined voltage based on the reference voltage selected by the switch. The settling time of the signal line by charge/discharge affects the display period, that is, the frame rate of the light emitting apparatus. Japanese Patent Laid-Open No. 2004-191536 discloses a technique for shortening the settling time.

Factors that vary the potential of the signal line are the potential difference between the signal line and the predetermined reference voltage selected by the DA conversion circuit and noise associated with the DA conversion operation. Examples of the noise are switching noise associated with a switching operation and coupling between the signal line and a digital signal of a control line for controlling a switch. The potential of a wire that supplies the reference voltage selected by the DA conversion operation can also vary in a similar manner. That is, to set the signal line to the predetermined voltage based on the reference voltage selected by the switch, the signal line and the wire that supplies the reference voltage need to be settled.

In Japanese Patent Laid-Open No. 2004-191536, the signal line is precharged to make the potential difference between the signal line and the predetermined reference voltage selected by the DA conversion circuit small, thereby shortening the charge/discharge time. On the other hand, the influence of noise associated with the DA conversion operation cannot be reduced. In a configuration in which the reference voltage is shared by a plurality of DA conversion circuits, the same reference voltage may be selected by the plurality of DA conversion circuits. In this case, as compared to the operation of one DA conversion circuit, noise is superimposed by the operations of the plurality of DA conversion circuits, and the potential of the signal line that supplies the reference voltage may greatly vary. If the time to settle the selected reference voltage to a predetermined voltage is insufficient, the DA conversion circuits sharing the reference voltage cannot output a predetermined light emission signal and correct light emission is impossible. Also, since it depends on the number of DA conversion circuits that select the same reference voltage, and depends on the pattern of the light emission image, and the potential may be lowered by an increase of the number of pixels as well. To sufficiently settle the signal line and the reference voltage, the settling time needs to be longer, and this is tradeoff between the frame rate and the quality of the light emission image.

### SUMMARY OF THE INVENTION

The present disclosure provides, for example, a light emitting apparatus advantageous in improving the quality of a light emission image.

According to one aspect of the present invention, there is provided a light emitting apparatus comprising: a plurality of light emitting devices; a plurality of conversion circuits provided in correspondence with the plurality of light emitting devices, respectively; and a voltage generator configured to generate a plurality of reference voltages, wherein each of the plurality of conversion circuits converts, using the plurality of reference voltages generated by the voltage generator, a digital signal supplied from an outside into an analog signal for driving one corresponding light emitting device of the plurality of light emitting devices, at least one reference voltage of the plurality of reference voltages is supplied from the voltage generator to each of the plurality of conversion circuits via a buffer circuit, the plurality of conversion circuits include a first group of conversion circuits to which the at least one reference voltage is supplied via a first buffer circuit, and a second group of conversion circuits to which the at least one reference voltage is supplied via a second buffer circuit, and the first buffer circuit and the second buffer circuit are connected in series, and an output of the first buffer circuit is input to the second buffer circuit.

Further features of the present invention will become apparent from the following description of exemplary embodiments with reference to the attached drawings.

### BRIEF DESCRIPTION OF THE DRAWINGS

FIG. 1 is a block diagram showing an example of the configuration of a light emitting apparatus according to the first embodiment;

FIG. 2 is an equivalent circuit diagram of a voltage generation circuit and column DAC circuits according to the first embodiment;

FIG. 3 is a circuit diagram showing an example of the equivalent circuit of a buffer circuit;

FIG. 4 is a circuit diagram showing an example of the equivalent circuit of a buffer circuit;

FIG. 5 is a circuit diagram showing an example of the equivalent circuit of a buffer circuit;

FIG. 6 is a circuit diagram showing an example of the equivalent circuit of a buffer circuit;

FIG. 7 is an equivalent circuit diagram of the voltage generation circuit and the column DAC circuits according to the first embodiment (modification);

FIG. 8 is an equivalent circuit diagram of a voltage generation circuit and column DAC circuits according to the second embodiment;

FIG. 9 is an equivalent circuit diagram of the voltage generation circuit and the column DAC circuits according to the second first embodiment (modification);

FIG. 10 is an equivalent circuit diagram of a voltage generation circuit and column DAC circuits according to the third embodiment;

FIG. 11 is an equivalent circuit diagram of the voltage generation circuit and the column DAC circuits according to the third embodiment (modification);

FIG. 12 is an equivalent circuit diagram of a voltage generation circuit and column DAC circuits according to the fourth embodiment;

FIG. 13 is an equivalent circuit diagram of a voltage generation circuit and column DAC circuits according to the fifth embodiment;

FIG. 14 is a view for explaining the operation timing of each column DAC circuit;

FIGS. 15A and 15B are block diagrams showing a light emitting apparatus (first configuration example) according to the sixth embodiment;

FIG. 16 is a block diagram showing the light emitting apparatus (second configuration example) according to the sixth embodiment;

FIGS. 17A and 17B are sectional views showing an example of the configuration of a pixel of the light emitting apparatus shown in FIG. 1;

FIG. 18 is a view showing an example of a display apparatus using the light emitting apparatus according to each embodiment;

FIG. 19 is a view showing an example of a photoelectric conversion apparatus using the light emitting apparatus according to each embodiment;

FIG. 20 is a view showing an example of an electronic device using the light emitting apparatus according to each embodiment;

FIGS. 21A and 21B are views showing examples of a display apparatus using the light emitting apparatus according to each embodiment;

FIG. 22 is a view showing an example of an illumination apparatus using the light emitting apparatus according to each embodiment;

FIG. 23 is a view showing an example of a moving body using the light emitting apparatus according to each embodiment; and

FIGS. 24A and 24B are views showing examples of a wearable device using the light emitting apparatus according to each embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

Light emitting apparatuses 10 according to the embodiments of the present invention will now be described. Note that all the following embodiments are mere examples of the present invention, and numerical values, shapes, materials, constituent elements, and arrangements and connection forms of the constituent elements are not intended to limit the scope of the present invention.

### First Embodiment

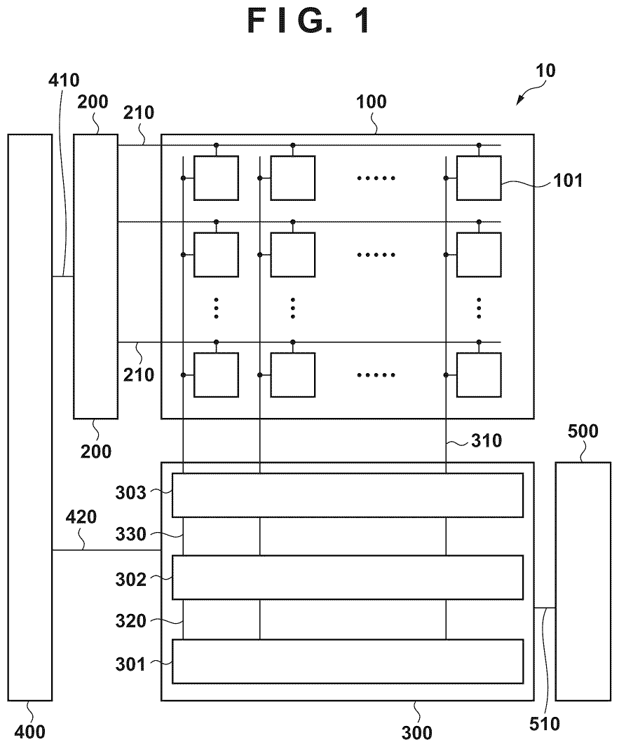

The first embodiment of the present invention will be described. FIG. 1 is a block diagram showing an example of the configuration of a light emitting apparatus 10 according to this embodiment. A pixel array 100 (pixel portion) includes a plurality of pixels 101 (a plurality of light emitting devices) that are arranged two-dimensionally (in a matrix) on a substrate across a plurality of rows and a plurality of columns. A control signal is input from a vertical scanning circuit 200 to the pixels 101 via scanning lines 210, and a luminance signal voltage is input as an image signal from a signal output circuit 300 to the pixels 101 via signal lines 310. The vertical scanning circuit 200 and the signal output circuit 300 are controlled by a control circuit 400 (controller) via a plurality of control lines 410 and 420, respectively. Each pixel 101 includes a light emitting diode (light emitting device) and emits light in a light emission amount corresponding to the input luminance signal voltage. Here, each pixel 101 may include a plurality of sub-pixels arranged for colors. In this case, the signal line 310 is arranged for each column based on each sub-pixel as a reference. For example, if one pixel includes three sub-pixels, three signal lines 310 can be arranged for one pixel column.

The signal output circuit 300 includes a horizontal scanning circuit 301, a column DAC circuit 302, and a column driver circuit 303.

The horizontal scanning circuit 301 is a transfer circuit that scans image data in one direction (horizontal direction) and transfers it as a digital signal to each of a plurality of column DAC circuits 302. The horizontal scanning circuit 301 includes a plurality of memories each of which holds the digital signal scanned in the one direction and transferred to each of the plurality of column DAC circuits 302,

In FIG. 1, the column DAC circuit 302 is shown as one block, but a plurality of column DAC circuits 302 are provided in correspondence with a plurality of pixel columns (the plurality of light emitting devices) in the pixel array 100. That is, the plurality of column DAC circuits 302 are provided such that one column DAC circuit 302 corresponds to one pixel column. Each of the plurality of column DAC circuits 302 is a conversion circuit that converts a digital signal supplied from the outside (more specifically, the horizontal scanning circuit 301) into an analog signal for driving the pixels 101 of a corresponding one of the plurality of pixel columns using a plurality of reference voltages.

Also, the column driver circuit 303 is shown as one block in FIG. 1, but a plurality of column driver circuits 303 are provided in correspondence with the plurality of pixel columns in the pixel array 100. That is, the plurality of column driver circuits 303 are provided such that one column driver circuit 303 corresponds to one column DAC circuit and one pixel column. Each of the plurality of column driver circuits 303 is a driving circuit that drives a corresponding one of the plurality of pixel columns by an analog signal output from a corresponding one of the plurality of column DAC circuits 302. Note that “DAC” is short for Digital/Analog Converter.

In the light emitting apparatus 10 according to this embodiment, image data is scanned by the horizontal scanning circuit 301, input to each column DAC circuit 302 via a DAC control signal line 320 of each column, and converted into an analog voltage by each column DAC circuit 302. The analog voltage is input as a luminance signal voltage to each column driver circuit 303 via a DAC output line 330 of each column. Each column driver circuit 303 inputs the analog signal (luminance signal voltage) input from the column DAC circuit 302 to the pixels 101 (light emitting devices) of each column via the signal line 310, thereby driving the pixels 101 of each column.

A voltage generation circuit 500 (voltage generator) generates, as a plurality of reference voltages, a plurality of analog voltages Vref in number according to the image data (for example, 256 analog voltages if the image data is 8-bit data). The plurality of reference voltages generated by the voltage generation circuit 500 are supplied to the signal output circuit 300 via a reference voltage line 510. Also, the voltage generation circuit 500 may generate a reference voltage to be used for variation correction of the signal output circuit 300 and the pixels 101. In this case, the reference voltage for correction can be supplied to the pixels 101 via the column driver circuits 303 and the signal lines 310.

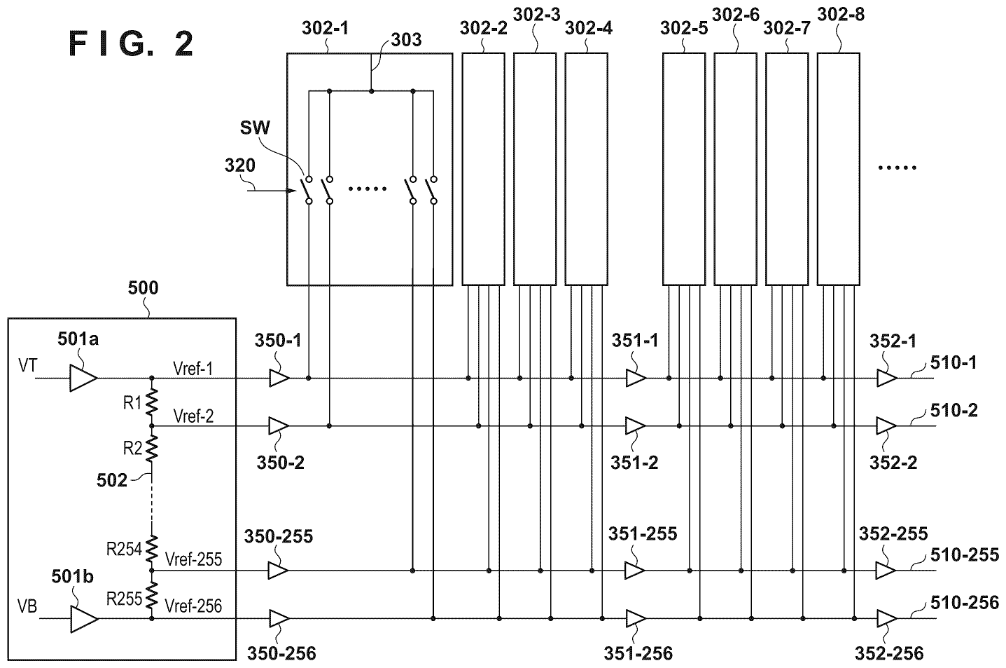

FIG. 2 is an equivalent circuit diagram of the voltage generation circuit 500 and the plurality of column DAC circuits 302 in the light emitting apparatus 10 according to this embodiment. FIG. 2 shows an example in which image data is formed by 8 bits, and identification codes “−1 to 256” are added to the column DAC circuits 302, the reference voltage lines 510, the analog signals Vref, and buffer circuits 350, 351, and 352. In the following explanation, the identification codes are sometimes omitted and, in this case, it may be understood that the elements with “−1 to 256” are collectively referred to.

The voltage generation circuit 500 includes a resistor string 502 formed by a plurality of resistors R1 to R255 connected in series between two terminals, generates a plurality of analog voltages Vref-1 to Vref-256 by the resistor string 502, and outputs these to the reference voltage lines 510-1 to 510-256. To one of the two terminals to which the resistor string 502 is connected, a voltage VT is applied via a buffer circuit 501a, and a voltage VB is applied to the other via a buffer circuit 501b. The voltages VT and VB may be supplied from the outside of the light emitting apparatus 10, or may be generated in the light emitting apparatus 10.

The plurality of analog voltages Vref-1 to Vref-256 (the plurality of reference voltages) generated by the voltage generation circuit 500 are supplied to each of the plurality of column DAC circuits 302 via the reference voltage lines 510-1 to 510-256. The voltage generation circuit 500 and the plurality of column DAC circuits 302 are connected via buffer circuits arranged on the reference voltage lines 510-1 to 510-256. Also, each column DAC circuit 302 includes a plurality of switches SW to which the analog voltages Vref are supplied, and one analog voltage Vref according to image data is selected by the plurality of switches SW. Thus, the digital signal input as the image data is converted into an analog signal (analog voltage). The plurality of switches SW in each column DAC circuit 302 may be understood to form a digital/analog converter.

In the light emitting apparatus 10 according to this embodiment, at least one analog voltage Vref of the plurality of analog voltages Vref-1 to Vref-256 generated by the voltage generation circuit 500 is supplied from the voltage generation circuit 500 to each of the plurality of column DAC circuits 302 via a buffer circuit. The plurality of column DAC circuits 302 can include two or more column DAC circuits 302 (for example, the column DAC circuits 302-1 to 302-4) to which the at least one analog voltage Vref is supplied via a common buffer circuit. In the example shown in FIG. 2, the analog voltage Vref is supplied to the column DAC circuits 302-1 to 302-4 (a first group of conversion circuits) via the common buffer circuit 350 (first buffer circuit). In addition, the analog voltage Vref is supplied to the column DAC circuits 302-5 to 302-8 (a second group of conversion circuits) via the common buffer circuit 351 (second buffer circuit). The analog voltage Vref is supplied to the column DAC circuits 302 subsequent to the column DAC circuit 302-8 via the common buffer circuit 352. The buffer circuits 350 to 352 are connected in series, the output of the buffer circuit 350 is input to the buffer circuit 351, and the output of the buffer circuit 351 is input to the buffer circuit 352.

The operation of the light emitting apparatus 10 without buffer circuits provided will be described here. At the time the operation of the column DAC circuit 302, the analog voltage Vref selected by the switch SW transiently varies due to the potential difference to the DAC output line 330, switching noise caused by the operation of the switch SW, coupling with the DAC control signal line 320 that controls the switch, or the like. To settle the reference voltage line 510 to the predetermined analog voltage Vref, a response time based on a time constant determined by the resistance value of the resistor string 502, the wiring parasitic resistance and the wiring parasitic capacitance of the reference voltage line 510, and the input parasitic capacitance of the column driver circuit 303 is necessary. In addition, since the analog voltage Vref is shared by the plurality of column DAC circuits 302, depending on the image data, the same analog voltage Vref may simultaneously be selected by a plurality of column DAC circuits. If the number of column DAC circuits 302 simultaneously selecting the same analog voltage Vref is large, the transient potential variation amount associated with the DA conversion operation of the column DAC circuits 302 increases, and the input parasitic capacitance of the column driver circuits 303 also increases as much as the number of columns. For this reason, the necessary settling time may increase. If no sufficient settling time can be ensured, this may be a factor that impedes a correct light emitting operation based on image data. Also, the plurality of column DAC circuits 302 selecting the same analog voltage Vref cannot perform a correct light emitting operation and, for example, horizontal stripes or horizontal smearing may be observed in a light emission image by crosstalk between the column DAC circuits 302. These lower the quality of a light emission image.

In the light emitting apparatus 10 according to this embodiment, the analog voltage Vref is supplied to the column DAC circuits 302 via the buffer circuits 350 arranged on the reference voltage lines 510. With this configuration, as compared to a case where the analog voltage Vref is directly supplied for the voltage generation circuit 500 (resistor string 502) to each column DAC circuit 302, the time constant corresponding to each resistance can be reduced. In addition, the wiring parasitic resistance and the wiring parasitic capacitance of the reference voltage line 510 and the input parasitic capacitance of the column driver circuit 303 are driven by the buffer circuit 350. For this reason, as compared to a case where the buffer circuit 350 is not arranged, it is possible to reduce the transient variation of the analog voltage Vref caused by the operation of the column DAC circuit 302 and shorten the settling time. In the light emitting apparatus 10 according to this embodiment, as shown in FIG. 2, the buffer circuits 351 and 352 are arranged for every four columns of column DAC circuits 302 to reduce the load on one buffer circuit, thereby further shortening the settling time. Also, when the buffer circuits are arranged between the columns as well, the crosstalk between the columns can be reduced. For example, in the example shown in FIG. 2, the buffer circuits 351 are arranged between the column DAC circuits 302-1 to 302-4 and the column DAC circuits 302-5 to 302-8. When the buffer circuits 351 are arranged, even if a transient potential variation occurs in the reference voltage lines 510 connected to the column DAC circuits 302-5 to 302-8, propagation of the transient potential variation to the reference voltage lines 510 connected to the column DAC circuits 302-1 to 302-4 is suppressed. That is, it is possible to reduce the crosstalk between the column DAC circuits 302-1 to 302-4 and the column DAC circuits 302-5 to 302-8.

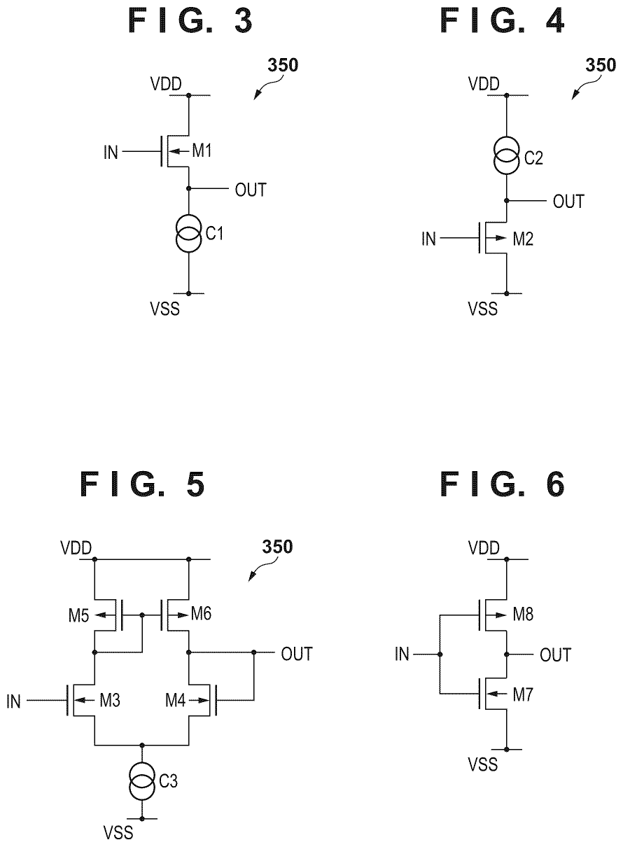

Next, an example of the configuration of the buffer circuits used in the light emitting apparatus 10 according to this embodiment will be described. FIGS. 3 to 5 are circuit diagrams showing examples of the equivalent circuit of the buffer circuits 350 to 352 or the buffer circuits 501a and 501b. FIG. 3 shows an example in which a buffer circuit is constituted by a source follower formed by an NMOS transistor M1 and a current source C1. FIG. 4 shows an example in which a buffer circuit is constituted by a source follower formed by a PMOS transistor M2 and a current source C2. FIG. 5 shows an example in which a buffer circuit is constituted by a differential amplification circuit formed by NMOS transistors M3 and M4, PMOS transistors M5 and M6, and a current source C3, which is a unity gain buffer in which an inverting input terminal and an output terminal are short-circuited. Note that FIGS. 3 to 5 representatively show the configuration examples of the buffer circuit 350, but the same configuration examples can be employed for the remaining buffer circuits 351, 352, 501a, and 501b as well.

Selection and/or arrangement of the buffer circuits shown in FIGS. 3 to 5 can be determined in accordance with, for example, an input/output range according to the DC level of the analog voltage Vref, an allowable layout area or power consumption, an input/output impedance, or the like. Different configurations may be applied to the buffer circuits 350-1 to 350-256, or different configurations may be applied to the buffer circuits 350 to 352. For example, when making the input/output levels of the buffer circuits match with respect to the analog voltage Vref, the unity gain buffer shown in FIG. 5 can be applied (selected) as the buffer circuits. As another example, when level-shifting the analog voltage Vref, the source follower shown in FIG. 3 or 4 can be applied (selected) as the buffer circuits. In this case, the buffer circuits may be allowed to perform different level shift operations by applying the source follower shown in FIG. 3 to the buffer circuits 350 and applying the source follower shown in FIG. 4 to the buffer circuits 351. Alternatively, the source follower shown in FIG. 3 or 4 may be applied to the buffer circuits 350, and the unity gain buffer shown in FIG. 5 may be applied to the buffer circuits 351.

Even in a case where the buffer circuits have the same configuration, the application (arrangement) may be done after the sizes of the MOS transistors and the current value of the current source are adjusted in accordance with noise or a necessary driving force. For example, assume a case where the configuration shown in FIG. 3 is applied to each of the buffer circuits 501a, 501b, and 350 to 352. In this case, to obtain the buffer circuit 501 with low noise and a high driving force, as compared to the buffer circuit 350, adjustment is preferably performed such that the gate width of the NMOS transistor is increased and/or the current value of the current source C1 is increased. In the viewpoint of reducing noise of the buffer circuit 350, the power of the buffer circuit 350 (for example, the current value of the current source) is preferably made larger than the power of the buffer circuit 351. In addition, the area (for example, the gate width) of the buffer circuit 350 is preferably made larger than the area of the buffer circuit 351. The noise of the buffer circuit 350 can thus be made smaller than the noise of the buffer circuit 351.

Here, image data transmitted by the horizontal scanning circuit 301 is so-called digital data. A buffer circuit used to transmit the digital data can be constituted by, for example, an inverter formed by an NMOS transistor M7 and a PMOS transistor M8, as shown in FIG. 6. That is, in terms of whether the signal to be buffered is an analog signal or a digital signal, whether to apply one of the configurations shown in FIGS. 3 to 5 or the configuration shown in FIG. 6 to the buffer circuit can be selected. If the signal to be buffered is an analog signal, one of the configurations shown in FIGS. 3 to 5 is applied to the buffer circuit to transmit a specific DC level. On the other hand, if the signal to be buffered is a digital signal, the configuration shown in FIG. 6 is applied to the buffer circuit to transmit a signal that swings between a power supply VDD and ground VSS. In this embodiment, one of the configurations shown in FIGS. 3 to 5 can be applied to the buffer circuits used to transmit the analog voltage Vref, and the configuration shown in FIG. 6 can be applied to the buffer circuits used to transmit image data that is digital data.

Each buffer circuit can be designed, for example, from the following viewpoint. In a case of a buffer circuit that transmits an analog signal (the configurations shown in FIGS. 3 to 5), the size of the MOS transistor and the current value of the current source can be determined to, for example, reduce noise. On the other hand, in a case of a buffer circuit that transmits a digital signal (the configuration shown in FIG. 6), the size of the MOS transistor can be determined in accordance with, for example, the transmission frequency or the load on the next stage. Also, when buffering an analog signal, the value of the power supply VDD in FIGS. 3 to 6 can be determined in accordance with the dynamic range of the analog signal. When buffering a digital signal, the value can be determined in accordance with the transmission speed or power. Furthermore, in a case of an analog signal, the array period of the buffer circuits can be determined in accordance with the settling time at the time of occurrence of a transient potential variation. In a case of a digital signal, the array period can be determined in accordance with the transmission speed. In the example shown in FIG. 2, the buffer circuits 350 to 352 that buffer an analog signal (analog voltage Vref) are arranged for every four columns of column DAC circuits 302 (that is, at a period of four columns).

Next, power supply connection of the buffer circuits and the like will be described. The voltage generation circuit 500, the buffer circuits 350 to 352, and the column DAC circuits 302 may be connected to different power supplies, or at least some of these may share a power supply. Also, the buffer circuits 350-1 to 350-256 may be connected to the same power supply or may be connected to different power supplies. For example, the voltage generation circuit 500 and the buffer circuits 350 to 352 are connected to the same power supply, and the column DAC circuits 302 are connected to a power supply different from that of the voltage generation circuit 500 and the buffer circuits 350 to 352. In the column DAC circuit 302, switching noise associated with a DAC conversion operation can be a factor of the transient potential variation of the connected power supply. On the other hand, in the voltage generation circuit 500 and the buffer circuits 350 to 352, the transient power supply variation is relatively small because a DC power supply is connected. That is, when the power supply of the voltage generation circuit 500 and the buffer circuits 350 to 352 and that of the column DAC circuits 302 are separated, the influence of the transient power supply variation associated with the operation of the column DAC circuits 302 on the other circuits can be reduced. Here, connection of a DC power supply can be application of a DC voltage.

As an example of a configuration of power supply connection for reducing the influence of the transient power supply variation associated with the operation of the column DAC circuits 302 on the other circuits, for example, the buffer circuits 350 to 352 commonly provided for one analog voltage Vref use the same power supply. Also, the buffer circuits 350 to 352 provided for one analog voltage Vref and the buffer circuits 350 to 352 provided for another analog voltage Vref may use different power supplies. The buffer circuits 350 to 352 and the column DAC circuits 302 provided for one analog voltage Vref may use the same power supply. The voltage generation circuit 500 and the buffer circuits 350 to 352 may use different power supplies. Note that the relationship of power supply connection is not limited to the above-described configuration examples.

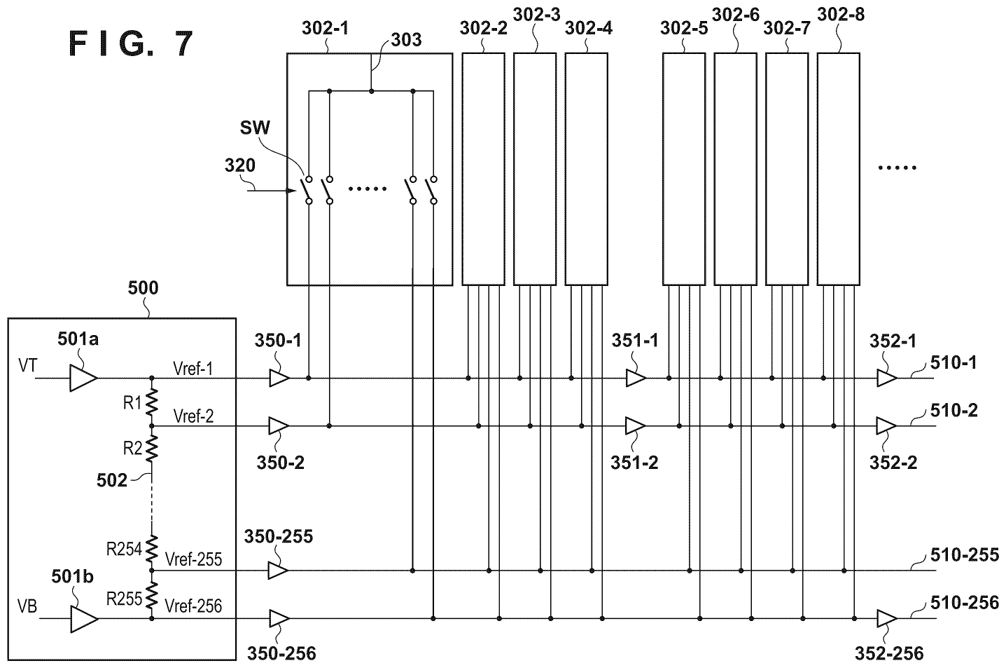

A modification of the light emitting apparatus 10 according to this embodiment will be described next. FIG. 7 is an equivalent circuit diagram of the voltage generation circuit 500 and the plurality of column DAC circuits 302 in the modification of the light emitting apparatus 10 according to this embodiment. In the example shown in FIG. 7, the buffer circuits 351-255 and 351-256 and the buffer circuit 352-255 are not arranged, as compared to the example shown in FIG. 2. More specifically, for the analog voltages Vref-1 and Vref-2 (first reference voltages), the common buffer circuits 350-1 and 350-2, 351-1 and 351-2, and 352-1 and 352-2 are provided for every first number of column DAC circuits 302 (at a 4-column period in FIG. 7). On the other hand, for the analog voltage Vref-256 (second reference voltage), the common buffer circuits 350-256 and 352-256 are provided for every column DAC circuits 302 in second number different from the first number (at an 8-column period in FIG. 7). Also, for the analog voltage Vref-255, the common buffer circuit 350-255 is provided for every column DAC circuits 302 in number different from the first and second numbers.

For example, if the analog voltage Vref-255 is selected in a luminance with which the influence of the transient variation associated with the operation of the column DAC circuits 302 is unnoticeable (for example, in a bright state), only the buffer circuit 350-255 is arranged on the reference voltage line 510-255 with priority on area saving and power saving. In addition, if the analog voltage Vref-256 is selected in a luminance with which the influence of the transient variation associated with the operation of the column DAC circuits 302 is unnoticeable, but the crosstalk between the column DAC circuits should particularly be reduced, buffer circuits are thinned out and arranged on the reference voltage line 510-256. That is, on the reference voltage line 510-256 in FIG. 7, the buffer circuits are thinned out as compared to the 4-column period shown in FIG. 2, and the buffer circuits 350-256 and 352-256 are arranged at the 8-column period. The example of criterion of the arrangement of the buffer circuits is merely an example, and the arrangement number and the arrangement period of buffers are appropriately determined in accordance with the layout area, power, and other criteria. Note that in the configuration example shown FIG. 7, the buffer circuits 351-255 and 351-256 and the buffer circuit 352-255 are not physically arranged, but the present invention is not limited to this. For example, although the buffer circuits are physically arranged, a power saving function and an input/output through function may be imparted to the buffer circuits, and user/nonuse of the buffer circuits may be switched in accordance with an operation mode.

Next, the characteristic variation of each buffer circuit and the variation of an emission luminance will be described. For example, if a buffer circuit is formed by the source follower shown in FIG. 3, the level shift amount may change between the buffer circuits 350-1 to 350-256 and between the buffer circuits 350 to 352 due to a variation of the threshold of the NMOS transistor M1 and a variation of the current value of the current source C1. If the level shift amount varies at random, an error of the emission luminance for image data occurs. For example, in the example shown in FIG. 2, this is the difference of linearity to the image data for every four columns as the array period of buffer circuits, and as for the light emission image, it may cause a step of luminance at the 4-column period or the difference of color reproductivity, resulting in lowing of the quality of the light emission image. Hence, each buffer circuit may have an output offset adjustment function or a threshold correction function. Also, a correction driving period may be provided in driving, a correction parameter may be acquired from the light emission image, and each buffer circuit may be corrected (adjusted) based on the correction parameter, or a correction mechanism may be provided in the column DAC circuit 302 or the column driver circuit 303. Alternatively, referring to the correction parameter obtained in the correction driving period, the control circuit 400 may correct the image data.

As described above, in the light emitting apparatus 10 according to this embodiment, at least one analog voltage Vref of the plurality of analog voltages Vref shared by the plurality of column DAC circuits 302 is supplied from the voltage generation circuit 500 to the column DAC circuits 302 via the buffer circuits. With this configuration, the crosstalk between the column DAC circuits 302 via the reference voltage lines 510 associated with the operation of the column DAC circuits 302 can be reduced. In addition, since the transient variation amount of the analog voltage Vref is reduced, and the necessary settling time is shortened, the quality of the light emission image can be improved without depending on an increase of the number of pixels or the pattern of an image.

### Second Embodiment

The second embodiment of the present invention will be described. This embodiment basically takes over the first embodiment, and matters except those to mentioned below can comply with the first embodiment.

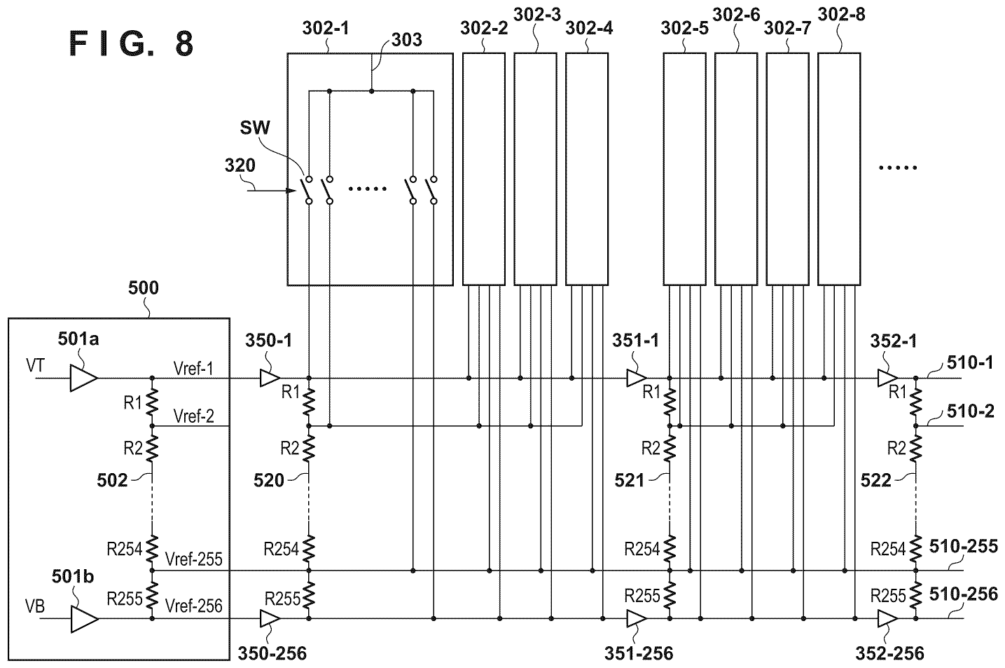

FIG. 8 is an equivalent circuit diagram of a voltage generation circuit 500 and a plurality of column DAC circuits 302 in a light emitting apparatus 10 according to this embodiment. In this embodiment, as compared to the configuration example of the first embodiment, resistor strings 520 to 522 (second resistor strings) are provided between the outputs of the buffer circuits 350 to 352. Differences from the first embodiment will mainly be described below.

In the first embodiment, the plurality of analog voltages Vref generated by the voltage generation circuit 500 are supplied to the column DAC circuits 302 via the buffer circuits 350 to 352. On the other hand, in this embodiment, buffer circuits 350 to 352 are arranged on each of reference voltage lines 510-1 and 510-256, and the resistor strings 520 to 522 are arranged between the outputs of the buffer circuits 350 to 352. A plurality of voltages generated by the resistor strings 520 to 522 are supplied to the column DAC circuits 302.

For example, in FIG. 8, analog voltages Vref-1 and Vref-256 are output from the voltage generation circuit 500. The resistor strings 520 to 522 are connected in parallel between the output terminal of the analog voltage Vref-1 (first reference voltage) and the output terminal of the analog voltage Vref-256 (second reference voltage). Each of the resistor strings 520 to 522 is formed by a plurality of resistors R1 to R255 connected in series between the output terminal of the analog voltage Vref-1 and the output terminal of the analog voltage Vref-256.

The resistor string 520 is connected between the two reference voltage lines 510-1 and 510-256 and generates a plurality of voltages (analog voltages) to be supplied to each of column DAC circuits 302-1 to 302-4. The analog voltages Vref-1 and Vref-256 are supplied from the voltage generation circuit 500 to the resistor string 520 via buffer circuits 350-1 and 350-256. Similarly, the resistor string 521 is connected between the two reference voltage lines 510-1 and 510-256 and generates a plurality of voltages (analog voltages) to be supplied to each of column DAC circuits 302-5 to 302-8. The analog voltages Vref-1 and Vref-256 are supplied from the voltage generation circuit 500 to the resistor string 521 via buffer circuits 351-1 and 351-256. Also, the resistor string 522 is connected between the two reference voltage lines 510-1 and 510-256 and generates a plurality of voltages (analog voltages) to be supplied to each of the column DAC circuits 302 subsequent to the column DAC circuit 302-8. The analog voltages Vref-1 and Vref-256 are supplied from the voltage generation circuit 500 to the resistor string 522 via buffer circuits 352-1 and 352-256.

As described in the first embodiment, the characteristic variation of each buffer circuit may affect the quality of a light emission image. Hence, in this embodiment, the buffer circuits are provided only for the analog voltages Vref-1 and Vref-256. The plurality of voltages to be generated by the resistor strings 520 to 522 provided between the outputs of the buffer circuits are determined by the resistance ratio of the plurality of resistors R1 to R255 that form the resistor strings. It is therefore possible to improve the linearity to image data as compared to the first embodiment. Also, when the resistance values or layout areas of the resistor strings are adjusted, power or the area an be reduced as compared to the configuration of the first embodiment in which the buffer circuits are arranged for each of the plurality of reference voltage lines 510.

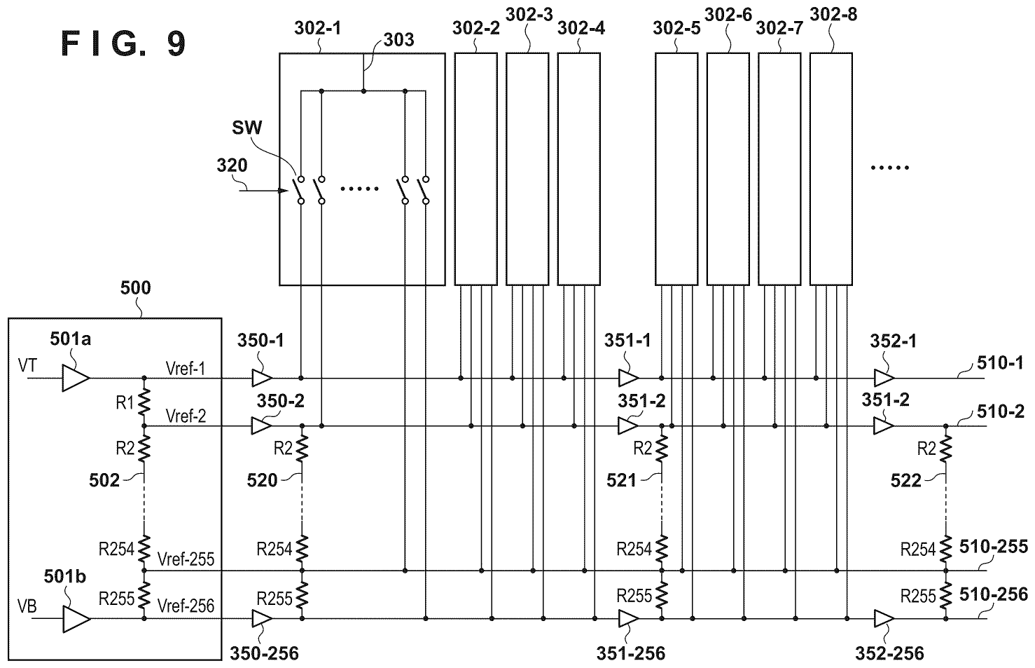

FIG. 9 shows a modification of the light emitting apparatus 10 according to this embodiment. In the example shown in FIG. 9, as compared to the example shown in FIG. 8 the resistor strings 520 to 522 are connected between two reference voltage lines 510-2 and 510-256. Each of the resistor strings 520 to 522 is formed by a plurality of resistors R2 to R255 connected in series between the output terminal of the analog voltage Vref-2 and the output terminal of the analog voltage Vref-256.

Analog voltages Vref-2 and Vref-256 are supplied from the voltage generation circuit 500 to the resistor string 520 via buffer circuits 350-2 and 350-256. To each of the column DAC circuits 302-1 to 302-4, the plurality of voltages (analog voltages) generated by the resistor string 520 are supplied and, additionally, the analog voltage Vref-1 from the voltage generation circuit 500 is supplied via the buffer circuit 350-1. Similarly, the analog voltages Vref-2 and Vref-256 are supplied from the voltage generation circuit 500 to the resistor string 521 via buffer circuits 351-2 and 351-256. To each of the column DAC circuits 302-5 to 302-8, the plurality of voltages (analog voltages) generated by the resistor string 521 are supplied and, additionally, the analog voltage Vref-1 from the voltage generation circuit 500 is supplied via the buffer circuit 351-1.

In the examples shown in FIGS. 8 and 9, it is possible to reduce the crosstalk between the column DAC circuits 302 sharing the plurality of analog voltages generated by the resistor strings 520 to 522. However, between the plurality of analog voltages, crosstalk may be generated via the resistors that form the resistor strings 520 to 522. In FIG. 9, as for the plurality of analog voltages to be supplied to the column DAC circuits 302, the analog voltage Vref-1 that is frequently selected by the column DAC circuits 302 and the remaining analog voltages are separated, thereby reducing the mutual influence. This can reduce the crosstalk between the plurality of analog voltages.

As described above, in the light emitting apparatus 10 according to this embodiment, the resistor strings 520 to 522 are arranged between the outputs of the buffer circuits, and the plurality of analog voltages generated by the resistor strings 520 to 522 are supplied to the column DAC circuits 302. With this configuration, the same effect as the first embodiment can be obtained, and lowering of the quality of the light emission image caused by the characteristic variation of each buffer circuit can be suppressed. Also, according to the configuration example shown in FIG. 9, since the crosstalk between the plurality of analog voltages can easily be reduced, the quality of the light emission image can further be improved as compared to the first embodiment.

### Third Embodiment

The third embodiment of the present invention will be described. This embodiment basically takes over the first embodiment, and matters except those to mentioned below can comply with the first embodiment. Also, in this embodiment, the second embodiment may be applied.

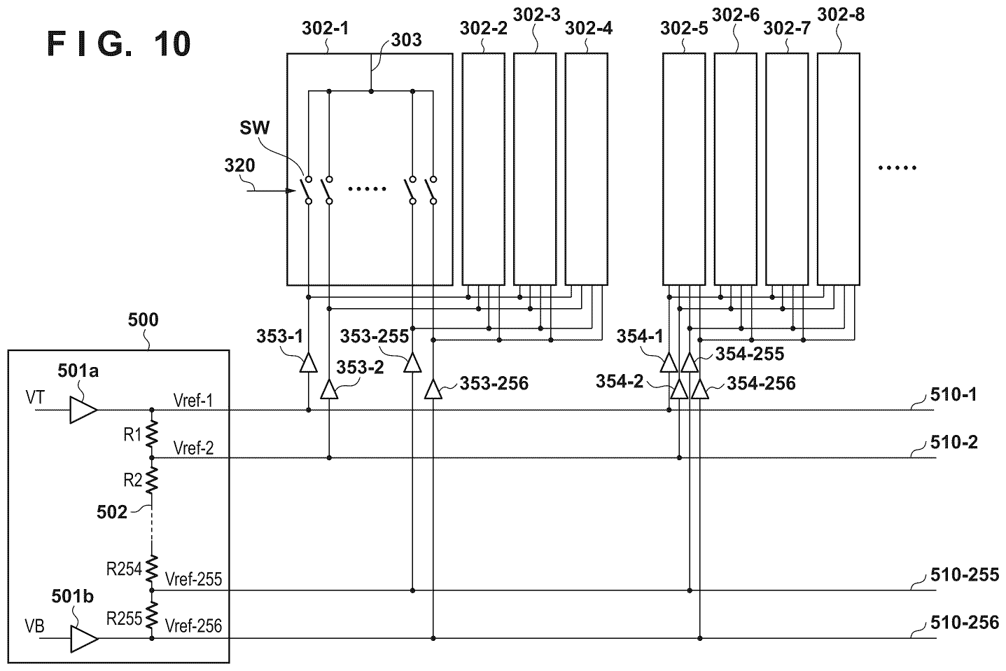

FIG. 10 is an equivalent circuit diagram of a voltage generation circuit 500 and a plurality of column DAC circuits 302 in a light emitting apparatus 10 according to this embodiment. In this embodiment, a plurality of analog voltages Vref generated by the voltage generation circuit 500 are supplied to the column DAC circuits 302 via buffer circuits 353 and 354 connected in parallel. Differences from the first embodiment will mainly be described below.

In the first embodiment, a configuration has been described in which the plurality of analog voltages Vref generated by the voltage generation circuit 500 are sequentially supplied to the column DAC circuits 302 via the buffer circuits 350 to 352 arranged in series on the reference voltage lines 510. For example, in the example shown in FIG. 2, the output of the voltage generation circuit 500 is connected to the input of the buffer circuit 350, and the output of the buffer circuit 350 is connected to each of the column DAC circuits 302-1 to 302-4 and also connected to the input of the buffer circuit 351. Similarly, the output of the buffer circuit 351 is connected to each of the column DAC circuits 302-5 to 302-8 and also connected to the input of the buffer circuit 352. This configuration will be referred to as “buffer circuits are arranged in series”.

On the other hand, in this embodiment, as shown in FIG. 10, the analog voltage Vref generated by the voltage generation circuit 500 is supplied to the column DAC circuits 302 via the buffer circuits 353 and 354 arranged in parallel on reference voltage lines 510. The common reference voltage lines 510 are connected to the inputs of the buffer circuits 353 and 354, the outputs of the buffer circuits 353 are connected to column DAC circuits 302-1 to 302-4, and the outputs of the buffer circuits 354 are connected to column DAC circuits 302-5 to 302-8. This configuration will be referred to as “buffers circuits are arranged in parallel”.

In the configuration according to this embodiment, the plurality of column DAC circuits 302 can include two or more column DAC circuits 302 (for example, the column DAC circuits 302-1 and 302-5) to which at least one analog voltage Vref is supplied via different buffer circuits. In the example shown in FIG. 10, analog voltages Vref-1 to Vref-256 are supplied to the column DAC circuits 302-1 to 302-4 (a first group of conversion circuits) via buffer circuits 353-1 to 353-256 (third buffer circuits). In addition, the analog voltages Vref-1 to Vref-256 are supplied to the column DAC circuits 302-5 to 302-8 (a second group of conversion circuits) via buffer circuits 354-1 to 354-256 (fourth buffer circuits). The buffer circuits 353 to 354 are connected in parallel.

In the configuration according to the first embodiment (for example, the example shown in FIG. 2), the settling time of the transient potential variation of the analog voltages Vref on the reference voltage lines 510 associated with the operation of the column DAC circuits 302 can be shortened by the buffer circuits (for example, the buffer circuits 350) arranged on the reference voltage lines 510. In the configuration according to this embodiment, the buffer circuits 353 and 354 are arranged in parallel, thereby reducing the influence associated with the operation of the plurality of column DAC circuits 302 on the analog voltages Vref on the reference voltage lines 510. That is, the transient potential variation itself of the analog voltages Vref associated with the operation of the plurality of column DAC circuits 302 is suppressed, and the crosstalk between the column DAC circuits 302 can be reduced. Also, in the configuration in which the plurality of buffer circuits are arranged in series, like the first embodiment, the quality of the light emission image may lower because noise or offset of the buffer circuits is superimposed on the analog voltages Vref. In this embodiment, the buffer circuits are arranged in parallel, thereby reducing lowering of the quality of the light emission image caused by noise or offset of the buffer circuits, as compared to the configuration in which the buffer circuits are arranged in series.

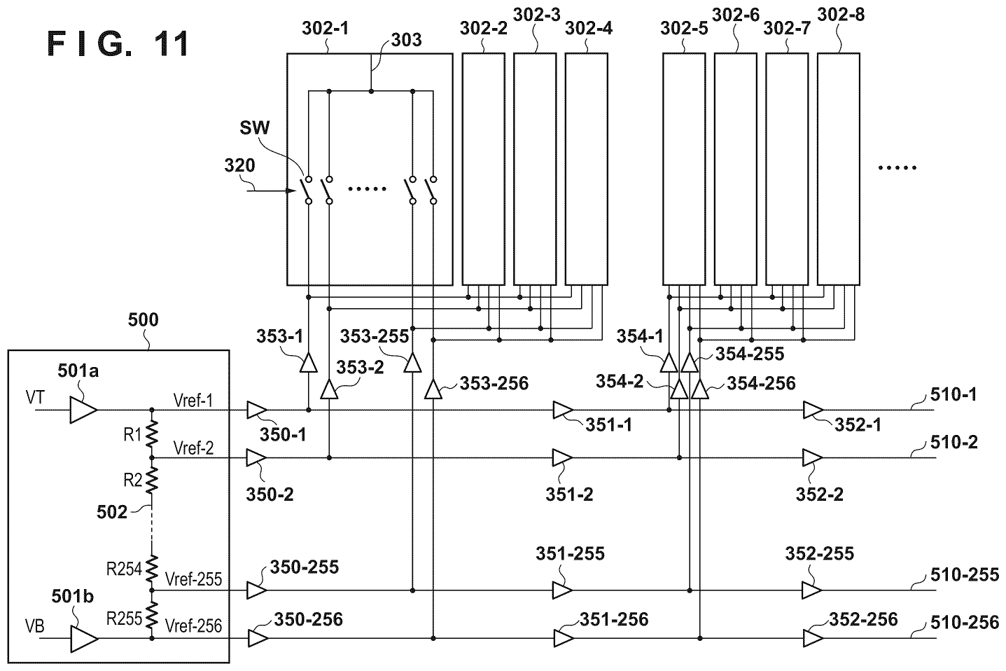

A modification of the light emitting apparatus 10 according to this embodiment will be described next. FIG. 11 is an equivalent circuit diagram of the voltage generation circuit 500 and the plurality of column DAC circuits 302 in the modification of the light emitting apparatus 10 according to this embodiment. The configuration shown in FIG. 11 is obtained by adding (applying) the configuration according to the first embodiment (FIG. 2) to the above-described configuration shown in FIG. 10. That is, in the configuration shown in FIG. 11, the buffer circuits 350 to 352 arranged in series and the buffer circuits 353 and 354 arranged in parallel are provided on the reference voltage lines 510. In this configuration, it is possible to reduce the influence associated with the operation of the column DAC circuits 302 on the analog voltages Vref on the reference voltage lines 510 and shorten the settling time of the transient potential variation of the analog voltage Vref. Note that the arrangement number and the arrangement period of the buffer circuits can appropriately be adjusted, as described in the first embodiment.

As described above, in the light emitting apparatus 10 according to this embodiment, the plurality of analog voltages Vref are supplied to the column DAC circuits 302 via the buffer circuits arranged in parallel on the reference voltage lines 510. With this configuration, the same effect as the first embodiment can be obtained, and the crosstalk between the column DAC circuits 302 associated with the operation of the plurality of column DAC circuits 302 can be reduced.

### Fourth Embodiment

The fourth embodiment of the present invention will be described. This embodiment basically takes over the first embodiment, and matters except those to mentioned below can comply with the first embodiment. Also, in this embodiment, the second embodiment and/or the third embodiment may be applied.

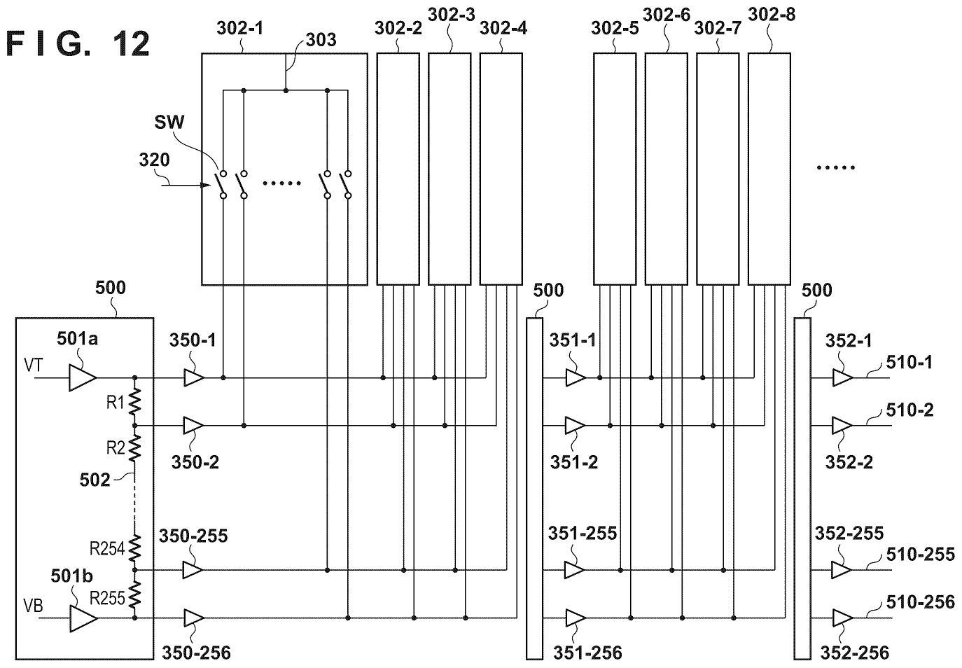

FIG. 12 is an equivalent circuit diagram of a voltage generation circuit 500 and a plurality of column DAC circuits 302 in a light emitting apparatus 10 according to this embodiment. In this embodiment, the voltage generation circuit 500 is individually provided for each of the plurality of column DAC circuits 302. Differences from the first embodiment will mainly be described below.

In the first embodiment, a configuration has been described, in which the plurality of analog voltages Vref output from one voltage generation circuit 500 are supplied to the plurality of column DAC circuits 302 via the buffer circuits arranged on the reference voltage lines 510. That is, in the first embodiment, one voltage generation circuit 500 is commonly used by a plurality of groups of column DAC circuits 302. On the other hand, in this embodiment, the voltage generation circuit 500 and buffer circuits 350 are individually arranged for each group of column DAC circuits 302. More specifically, the voltage generation circuits 500 and the buffer circuits 350 are individually arranged for a first group of column DAC circuits 302-1 to 302-4 and a second group of column DAC circuits 302-5 to 302-8. Since reference voltage lines 510 can thus be separated for each group of column DAC circuits 302, the crosstalk between the column DAC circuits 302 associated with the operation of the plurality of column DAC circuits 302 can be reduced.

Here, “a plurality of voltage generation circuits 500 are arranged” indicates that a plurality of voltage generation circuits 500 are arranged in correspondence with the plurality of column DAC circuits 302 arranged while extending in one direction. For example, if the block diagram of FIG. 1 shows the physical arrangement relationship of the constituent elements, a signal output circuit 300 is arranged on one side and the lower side of a pixel array 100, and the plurality of column DAC circuits 302 are arranged in the column direction. “Arranged in the column direction” will be referred to as “arranged while extending in one direction”. On the other hand, as another example of the configuration shown in FIG. 1, the signal output circuit 300 and the voltage generation circuit 500 corresponding to it may be arranged on the upper side of the pixel array 100 as well. In this case, the two voltage generation circuits 500 are arranged on the upper and lower sides of the pixel array 100. In this embodiment, this is not expressed as “a plurality of voltage generation circuits 500 are arranged”. In this embodiment, this is expressed as “one voltage generation circuit 500 arranged independently of each signal output circuit 300”. Note that in this embodiment, the voltage generation circuit 500 is arranged for every four columns of column DAC circuits 302. However, the voltage generation circuit 500 may be arranged for each column, or the voltage generation circuit 500 may be arranged for every different number of column DAC circuits 302.

In addition, voltages VT and VB to be supplied to each of the plurality of voltage generation circuits 500 may be supplied from a common signal line between the plurality of voltage generation circuits 500 or may be supplied from different signal lines. Also, the voltages VT an VB may be supplied between the plurality of voltage generation circuits 500 via buffer circuits.

As described above, in the light emitting apparatus 10 according to this embodiment, the voltage generation circuit 500 is arranged for each group of column DAC circuits 302. With this configuration, the same effect as the first embodiment can be obtained, and the crosstalk between the column DAC circuits 302 associated with the operation of the plurality of column DAC circuits 302 can be reduced.

### Fifth Embodiment

The fifth embodiment of the present invention will be described. This embodiment basically takes over the first embodiment, and matters except those to mentioned below can comply with the first embodiment. Also, in this embodiment, the second embodiment, the third embodiment, and/or the fourth embodiment may be applied.

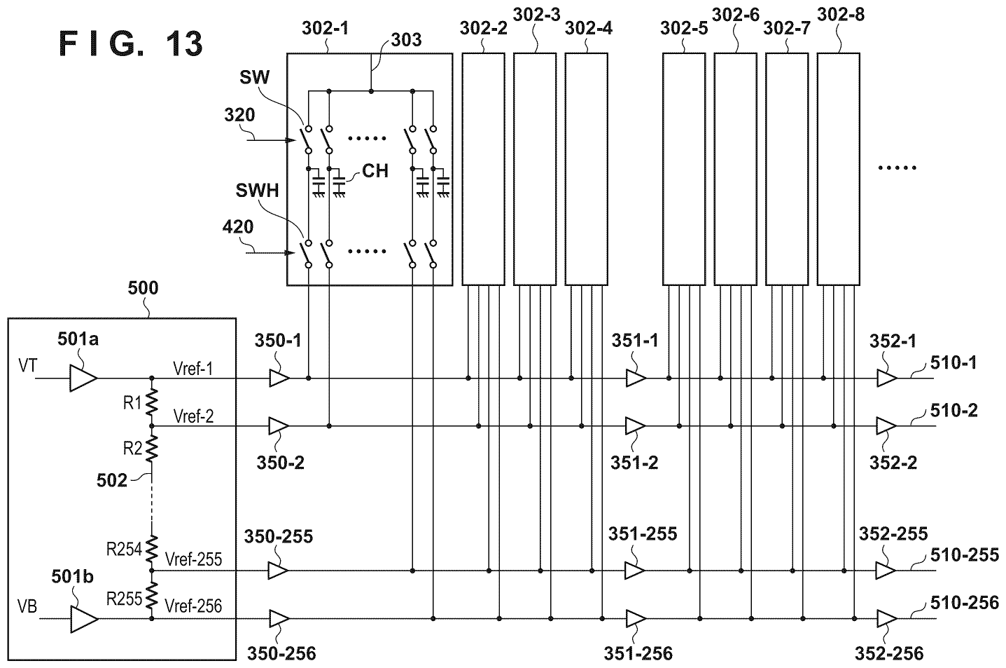

FIG. 13 is an equivalent circuit diagram of a voltage generation circuit 500 and a plurality of column DAC circuits 302 in a light emitting apparatus 10 according to this embodiment. In this embodiment, the arrangement of the voltage generation circuit 500, the plurality of column DAC circuits 302, and buffer circuits 350 to 352 is the same as in the first embodiment (FIG. 2). However, each column DAC circuit 302 according to this embodiment includes not only a digital/analog converter but also a holding circuit that temporarily holds a plurality of analog voltages Vref supplied from the voltage generation circuit 500. The digital/analog converter is formed by a plurality of switches SW, as described above, and converts a digital signal into an analog signal using the plurality of analog voltages Vref held in the holding circuits. The holding circuit can be formed by a switch SWH and a holding capacitor CH. Differences from the first embodiment will mainly be described below.

In the light emitting apparatus 10 according to this embodiment, a plurality of sets each including the switch SWH and the holding capacitor CH are provided as a holding circuit in each column DAC circuit 302. The plurality of sets each including the switch SWH and the holding capacitor CH are arranged in correspondence with the plurality of analog voltages Vref, that is, in correspondence with the plurality of switches SW. Each switch SWH of the holding circuit can be controlled by a control circuit 400 via a control line 420. In each column DAC circuit 302 having such a configuration, the plurality of analog voltages Vref supplied from the voltage generation circuit 500 via reference voltage lines 510 can temporarily be held in the holding capacitors CH.

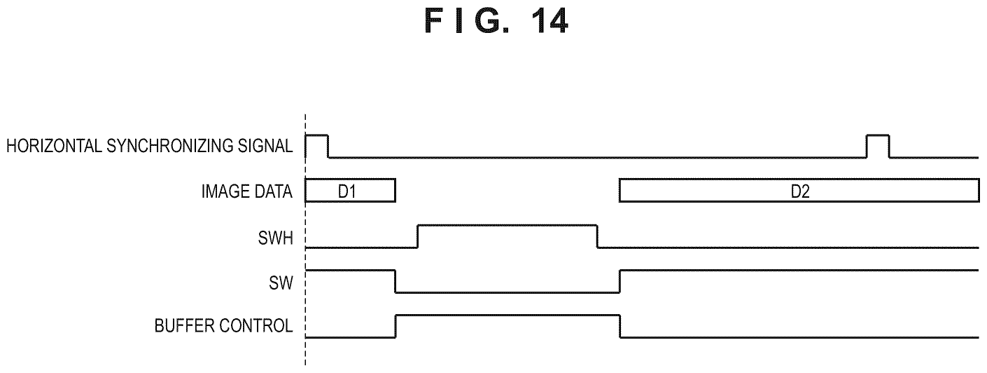

FIG. 14 is a view for explaining the operation timing of each column DAC circuit 302 shown in FIG. 13. FIG. 14 shows a horizontal synchronizing signal that is the period of row scanning, the switching timing between image data D1 and image data D2, the operation timing of the switch SWH, and the operation timing of the switch SW. The switch SWH and the switch SW are turned on when the control signal is at high level and off at low level. In an operation per row, the switch SW is controlled based on the image data D1 of the preceding row, after the switch SW is turned off, the switch SWH is turned on, and the holding capacitor CH and the reference voltage line 510 are connected. When the switch SWH is turned off, the analog voltage Vref is held in the holding capacitor CH. After the analog voltage Vref is held in the holding capacitor CH, the switch SW is controlled (turned on) based on the image data D2. With this operation, the reference voltage line 510 and the holding capacitor CH are disconnected by the switch SWH in a state in which the switch SW is ON. For this reason, even in a case where the same analog voltage Vref is selected between the column DAC circuits 302, the crosstalk between the column DAC circuits 302 can be reduced. Thus, as for the settling time of the transient potential variation associated with the operation of the column DAC circuits 302, the dependence on an increase of the number of pixels or the pattern of an image can be made low, and the influence on degradation of the quality of the light emission image can be reduced. Note that the capacitance value of the holding capacitor CH can be set in consideration of a time constant allowed as one index.

Also, buffer control shown in FIG. 14 is, for example, power control of the buffer circuits 350 to 352, a low period indicates power-off, and a high period indicates power-on. For example, as shown in FIG. 14, during a period in which the holding capacitor CH holds the analog voltage Vref (that is, a period in which the switch SWH if OFF), the buffer circuits 350 to 352 are powered off (that is, the operations of the buffer circuits 350 to 352 are stopped). This can reduce the power consumption of the light emitting apparatus 10.

Here, in this embodiment, an example in which for each column DAC circuit 302, a holding circuit is provided in correspondence with each of the plurality of analog voltages Vref supplied from the voltage generation circuit 500 has been described. However, the present invention is not limited to this. For example, for each column DAC circuit 302, a holding circuit may be provided only for at least one analog voltage Vref of the plurality of analog voltages Vref.

As described above, in the light emitting apparatus 10 according to this embodiment, the holding circuits that temporarily hold the plurality of analog voltages Vref supplied from the voltage generation circuit 500 are provided in each column DAC circuit 302. In each column DAC circuit 302, after the analog voltage Vref supplied via the buffer circuit on the reference voltage line 510 is held in the holding capacitor CH, the analog voltage Vref is selected based on image data (that is, a digital signal is converted into an analog signal). With this configuration, the same effect as the first embodiment can be obtained, and the crosstalk between the column DAC circuits 302 via the reference voltage lines 510 associated with the operation of the plurality of column DAC circuits 302 can be reduced.

### Sixth Embodiment

The sixth embodiment of the present invention will be described. In this embodiment, correction of an emission luminance in each of a plurality of pixels 101 (light emitting devices) will be described. This embodiment basically takes over the first embodiment, and matters except those to mentioned below can comply with the first embodiment. Also, in this embodiment, the second embodiment, the third embodiment, the fourth embodiment, and/or the fifth embodiment may be applied.

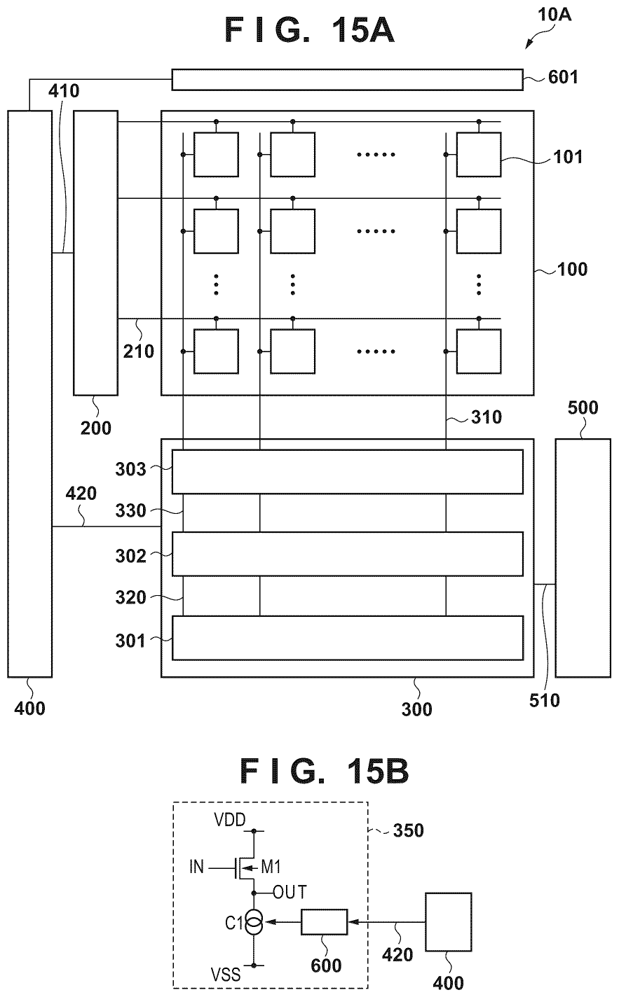

FIG. 15A is a block diagram showing a light emitting apparatus 10A of a first configuration example according to this embodiment. The light emitting apparatus 10A of the first configuration example shown in FIG. 15A further includes a first detector 601, as compared to the light emitting apparatus 10 according to the first embodiment shown in FIG. 1. The first detector 601 detects an emission luminance in each of the plurality of pixels 101 (light emitting devices). Detection of the emission luminance by the first detector 601 can be done in the calibration period of the light emitting apparatus 10A. Also, each of a plurality of buffer circuits provided in the light emitting apparatus 10A includes an output offset adjustment mechanism 600. As an example, FIG. 15B shows an example of the configuration of a buffer circuit 350 formed by the source follower shown in FIG. 3. The output offset adjustment mechanism 600 of the buffer circuit 350 can be configured to adjust (change) the output of the buffer circuit 350 by adjusting (changing) the current value of a current source C1. Thus, based on the detection result of the first detector 601, a control circuit 400 can control the output of the buffer circuit 350 by the output offset adjustment mechanism 600 such that the emission luminance of each pixel 101 is corrected (for example, falls within an allowable range).

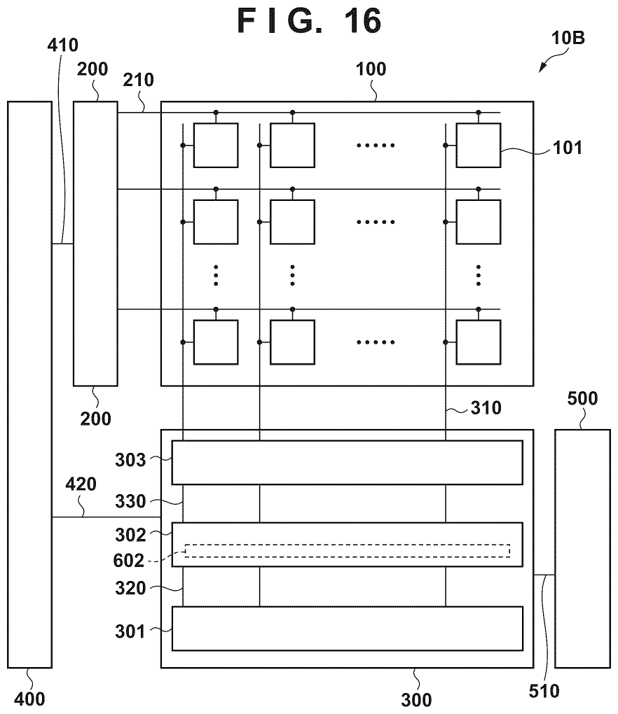

FIG. 16 is a block diagram showing a light emitting apparatus 10B of a second configuration example according to this embodiment. The light emitting apparatus 10B of the second configuration example shown in FIG. 16 further includes a second detector 602, as compared to the light emitting apparatus 10 according to the first embodiment shown in FIG. 1. The second detector 602 detects the output offset value between the plurality of buffer circuits provided in the light emitting apparatus 10B. Detection of the output offset value by the second detector 602 can be done in the calibration period of the light emitting apparatus 10B. Also, each of the plurality of buffer circuits can include the output offset adjustment mechanism 600, as described above with reference to FIG. 15B. Thus, based on the detection result of the second detector 602, the control circuit 400 can control the output of each buffer circuit by the output offset adjustment mechanism 600 such that the output offset value between the plurality of buffer circuits is corrected (for example, falls within an allowable range). That is, the emission luminance of each pixel 101 is corrected. Note that in the light emitting apparatus 10B of the second configuration example, the first detector 601 may further be provided, like the light emitting apparatus 10A of the first configuration example, and the emission luminance of each pixel 101 may be corrected based on the detection result of the first detector 601.

### [Configuration of Organic Light Emitting Device]

The organic light emitting device is provided by forming an insulating layer, a first electrode, an organic compound layer, and a second electrode on a substrate. A protection layer, a color filter, a microlens, and the like may be provided on a cathode. If a color filter is provided, a planarizing layer may be provided between the protection layer and the color filter. The planarizing layer can be formed using acrylic resin or the like. The same applies to a case where a planarizing layer is provided between the color filter and the microlens.

### [Substrate]

Quartz, glass, a silicon wafer, a resin, a metal, or the like may be used as a substrate. Furthermore, a switching device such as a transistor, a wiring pattern, and the like may be provided on the substrate, and an insulating layer may be provided thereon. The insulating layer may be made of any material as long as a contact hole can be formed so that the wiring pattern can be formed between the first electrode and the substrate and insulation from the unconnected wiring pattern can be ensured. For example, a resin such as polyimide, silicon oxide, silicon nitride, or the like may be used for the insulating layer.

### [Electrode]

A pair of electrodes can be used as the electrodes. The pair of electrodes can be an anode and a cathode. If an electric field is applied in the direction in which the organic light emitting device emits light, the electrode having a high potential is the anode, and the other is the cathode. It can also be said that the electrode that supplies holes to the light emitting layer is the anode and the electrode that supplies electrons is the cathode.

As the constituent material of the anode, a material having a large work function may be selected. For example, a metal such as gold, platinum, silver, copper, nickel, palladium, cobalt, selenium, vanadium, or tungsten, a mixture containing some of them, an alloy obtained by combining some of them, or a metal oxide such as tin oxide, zinc oxide, indium oxide, indium tin oxide (ITO), or zinc indium oxide can be used. Furthermore, a conductive polymer such as polyaniline, polypyrrole, or polythiophene can also be used as the constituent material of the anode.

One of these electrode materials may be used singly, or two or more of them may be used in combination. The anode may be formed by a single layer or a plurality of layers.

If the electrode is used as a reflective electrode, for example, chromium, aluminum, silver, titanium, tungsten, molybdenum, an alloy thereof, a stacked layer thereof, or the like can be used. The above materials can function as a reflective film having no role as an electrode. If a transparent electrode is used as the electrode, an oxide transparent conductive layer made of indium tin oxide (ITO), indium zinc oxide, or the like can be used, but the present invention is not limited thereto. A photolithography technique can be used to form the electrode.

On the other hand, as the constituent material of the cathode, a material having a small work function may be selected. Examples of the material include an alkali metal such as lithium, an alkaline earth metal such as calcium, a metal such as aluminum, titanium, manganese, silver, lead, or chromium, and a mixture containing some of them. Alternatively, an alloy obtained by combining these metals can also be used. For example, a magnesium-silver alloy, an aluminum-lithium alloy, an aluminum-magnesium alloy, a silver-copper alloy, a zinc-silver alloy, or the like can be used. A metal oxide such as indium tin oxide (ITO) can also be used. One of these electrode materials may be used singly, or two or more of them may be used in combination. The cathode may have a single-layer structure or a multilayer structure. Silver may be used as the cathode. To suppress aggregation of silver, a silver alloy may be used. The ratio of the alloy is not limited as long as aggregation of silver can be suppressed. For example, the ratio between silver and another metal may be 1:1, 3:1, or the like.

The cathode may be a top emission device using an oxide conductive layer made of ITO or the like, or may be a bottom emission device using a reflective electrode made of aluminum (Al) or the like, and is not particularly limited. The method of forming the cathode is not particularly limited, but if direct current sputtering or alternating current sputtering is used, the good coverage is achieved for the film to be formed, and the resistance of the cathode can be lowered.

### [Pixel Isolation Layer]

A pixel isolation layer may be formed by a so-called silicon oxide, such as silicon nitride (SiN), silicon oxynitride (SiON), or silicon oxide (SiO), formed using a Chemical Vapor Deposition (CVD) method. To increase the resistance in the in-plane direction of the organic compound layer, the organic compound layer, especially the hole transport layer may be thinly deposited on the side wall of the pixel isolation layer. More specifically, the organic compound layer can be deposited so as to have a thin film thickness on the side wall by increasing the taper angle of the side wall of the pixel isolation layer or the film thickness of the pixel isolation layer to increase vignetting during vapor deposition.

On the other hand, the taper angle of the side wall of the pixel isolation layer or the film thickness of the pixel isolation layer can be adjusted to the extent that no space is formed in the protection layer formed on the pixel isolation layer. Since no space is formed in the protection layer, it is possible to reduce generation of defects in the protection layer. Since generation of defects in the protection layer is reduced, a decrease in reliability caused by generation of a dark spot or occurrence of a conductive failure of the second electrode can be reduced.

According to this embodiment, even if the taper angle of the side wall of the pixel isolation layer is not acute, it is possible to effectively suppress leakage of charges to an adjacent pixel. As a result of this consideration, it has been found that the taper angle of 60° (inclusive) to 90° (inclusive) can sufficiently reduce the occurrence of defects. The film thickness of the pixel isolation layer may be 10 nm (inclusive) to 150 nm (inclusive). A similar effect can be obtained in an arrangement including only pixel electrodes without the pixel isolation layer. However, in this case, the film thickness of the pixel electrode is set to be equal to or smaller than half the film thickness of the organic layer or the end portion of the pixel electrode is formed to have a forward tapered shape of less than 60°. With this, short circuit of the organic light emitting device can be reduced.

Furthermore, in a case where the first electrode is the cathode and the second electrode is the anode, a high color gamut and low-voltage driving can be achieved by forming the electron transport material and charge transport layer and forming the light emitting layer on the charge transport layer.

### [Organic Compound Layer]

The organic compound layer may be formed by a single layer or a plurality of layers. If the organic compound layer includes a plurality of layers, the layers can be called a hole injection layer, a hole transport layer, an electron blocking layer, a light emitting layer, a hole blocking layer, an electron transport layer, and an electron injection layer in accordance with the functions of the layers. The organic compound layer is mainly formed from an organic compound but may contain inorganic atoms and an inorganic compound. For example, the organic compound layer may contain copper, lithium, magnesium, aluminum, iridium, platinum, molybdenum, zinc, or the like. The organic compound layer may be arranged between the first and second electrodes, and may be arranged in contact with the first and second electrodes. If a plurality of light emitting layers are provided, a charge generation portion may be arranged between the first light emitting layer and the second light emitting layer. The charge generation portion may contain an organic compound with a lowest unoccupied molecular orbital energy (LUMO) of −5.0 eV or less. The same applies to a case where a charge generating portion is provided between the second light emitting layer and the third light emitting layer.

### [Protection Layer]

A protection layer may be provided on the cathode. For example, by adhering glass provided with a moisture absorbing agent on the cathode, permeation of water or the like into the organic compound layer can be suppressed and occurrence of display defects can be suppressed. Furthermore, as another embodiment, a passivation layer made of silicon nitride or the like may be provided on the cathode to suppress permeation of water or the like into the organic compound layer. For example, the protection layer can be formed by forming the cathode, transferring it to another chamber without breaking the vacuum, and forming silicon nitride having a thickness of 2 μm by the CVD method. The protection layer may be provided using an atomic layer deposition (ALD) method after deposition of the protection layer using the CVD method. The material of the protection layer by the ALD method is not limited but can be silicon nitride, silicon oxide, aluminum oxide, or the like. Silicon nitride may further be formed by the CVD method on the protection layer formed by the ALD method. The protection layer formed by the ALD method may have a film thickness smaller than that of the protection layer formed by the CVD method. More specifically, the film thickness of the protection layer formed by the ALD method may be 50% or less, or 10% or less of that of the protection layer formed by the CVD method.

### [Color Filter]

A color filter may be provided on the protection layer. For example, a color filter considering the size of the organic light emitting device may be provided on another substrate, and the substrate with the color filter formed thereon may be bonded to the substrate with the organic light emitting device provided thereon. Alternatively, for example, a color filter may be patterned on the above-described protection layer using a photolithography technique. The color filter may be formed from a polymeric material.

### [Planarizing Layer]

A planarizing layer may be arranged between the color filter and the protection layer. The planarizing layer is provided to reduce unevenness of the layer below the planarizing layer. The planarizing layer may be called a material resin layer without limiting the purpose of the layer. The planarizing layer may be formed from an organic compound, and may be made of a low-molecular material or a polymeric material. In consideration of reduction of unevenness, a polymeric organic compound may be used for the planarizing layer.

The planarizing layers may be provided above and below the color filter. In that case, the same or different constituent materials may be used for these planarizing layers. More specifically, examples of the material of the planarizing layer include polyvinyl carbazole resin, polycarbonate resin, polyester resin, ABS resin, acrylic resin, polyimide resin, phenol resin, epoxy resin, silicone resin, and urea resin.

### [Microlens]

The organic light emitting apparatus may include an optical member such as a microlens on the light emission side. The microlens can be made of acrylic resin, epoxy resin, or the like. The microlens can aim to increase the amount of light extracted from the organic light emitting apparatus and control the direction of light to be extracted. The microlens can have a hemispherical shape. If the microlens has a hemispherical shape, among tangents contacting the hemisphere, there is a tangent parallel to the insulating layer, and the contact between the tangent and the hemisphere is the vertex of the microlens. The vertex of the microlens can be decided in the same manner even in an arbitrary sectional view. That is, among tangents contacting the semicircle of the microlens in a sectional view, there is a tangent parallel to the insulating layer, and the contact between the tangent and the semicircle is the vertex of the microlens.

Furthermore, the middle point of the microlens can also be defined. In the section of the microlens, a line segment from a point at which an arc shape ends to a point at which another arc shape ends is assumed, and the middle point of the line segment can be called the middle point of the microlens. A section for determining the vertex and the middle point may be a section perpendicular to the insulating layer.

The microlens includes a first surface including a convex portion and a second surface opposite to the first surface. The second surface can be arranged on the functional layer (light emitting layer) side of the first surface. For this arrangement, the microlens needs to be formed on the light emitting apparatus. If the functional layer is an organic layer, a process which produces high temperature in the manufacturing step of the microlens may be avoided. In addition, if it is configured to arrange the second surface on the functional layer side of the first surface, all the glass transition temperatures of an organic compound forming the organic layer may be 100° C. or more. For example, 130° C. or more is suitable.

### [Counter Substrate]

A counter substrate may be arranged on the planarizing layer. The counter substrate is called a counter substrate because it is provided at a position corresponding to the above-described substrate. The constituent material of the counter substrate can be the same as that of the above-described substrate. If the above-described substrate is the first substrate, the counter substrate can be the second substrate.

### [Organic Layer]

The organic compound layer (hole injection layer, hole transport layer, electron blocking layer, light emitting layer, hole blocking layer, electron transport layer, electron injection layer, and the like) forming the organic light emitting device according to an embodiment of the present disclosure may be formed by the method to be described below.

The organic compound layer forming the organic light emitting device according to the embodiment of the present disclosure can be formed by a dry process using a vacuum deposition method, an ionization deposition method, a sputtering method, a plasma method, or the like. Instead of the dry process, a wet process that forms a layer by dissolving a solute in an appropriate solvent and using a well-known coating method (for example, a spin coating method, a dipping method, a casting method, an LB method, an inkjet method, or the like) can be used.

Here, when the layer is formed by a vacuum deposition method, a solution coating method, or the like, crystallization or the like hardly occurs and excellent temporal stability is obtained. Furthermore, when the layer is formed using a coating method, it is possible to form the film in combination with a suitable binder resin.

Examples of the binder resin include polyvinyl carbazole resin, polycarbonate resin, polyester resin, ABS resin, acrylic resin, polyimide resin, phenol resin, epoxy resin, silicone resin, and urea resin. However, the binder resin is not limited to them.

One of these binder resins may be used singly as a homopolymer or a copolymer, or two or more of them may be used in combination. Furthermore, additives such as a well-known plasticizer, antioxidant, and an ultraviolet absorber may also be used as needed.

### [Pixel Circuit]

The light emitting apparatus can include a pixel circuit connected to the light emitting device. The pixel circuit may be an active matrix circuit that individually controls light emission of the first and second light emitting devices. The active matrix circuit may be a voltage or current programing circuit. A driving circuit includes a pixel circuit for each pixel. The pixel circuit can include a light emitting device, a transistor for controlling light emission luminance of the light emitting device, a transistor for controlling a light emission timing, a capacitor for holding the gate voltage of the transistor for controlling the light emission luminance, and a transistor for connection to GND without intervention of the light emitting device.

The light emitting apparatus includes a display region and a peripheral region arranged around the display region. The light emitting device includes the pixel circuit in the display region and a display control circuit in the peripheral region. The mobility of the transistor forming the pixel circuit may be smaller than that of a transistor forming the display control circuit.

The slope of the current-voltage characteristic of the transistor forming the pixel circuit may be smaller than that of the current-voltage characteristic of the transistor forming the display control circuit. The slope of the current-voltage characteristic can be measured by a so-called Vg-Ig characteristic.

The transistor forming the pixel circuit is a transistor connected to the light emitting device such as the first light emitting device.

### [Pixel]

The organic light emitting apparatus includes a plurality of pixels. Each pixel includes sub-pixels that emit light components of different colors. The sub-pixels may include, for example, R, G, and B emission colors, respectively.

In each pixel, a region also called a pixel opening emits light. The pixel opening can have a size of 5 μm (inclusive) to 15 μm (inclusive). More specifically, the pixel opening can have a size of 11 μm, 9.5 μm, 7.4 μm, 6.4 μm, or the like.

A distance between the sub-pixels can be 10 μm or less, and can be, more specifically, 8 μm, 7.4 μm, or 6.4 μm.

The pixels can have a known arrangement form in a plan view. For example, the pixels may have a stripe arrangement, a delta arrangement, a pentile arrangement, or a Bayer arrangement. The shape of each sub-pixel in a plan view may be any known shape. For example, a quadrangle such as a rectangle or a rhombus, a hexagon, or the like may be possible. A shape which is not a correct shape but is close to a rectangle is included in a rectangle, as a matter of course. The shape of the sub-pixel and the pixel arrangement can be used in combination.

### [Application of Organic Light Emitting Device of Embodiment of Present Disclosure]

The organic light emitting device according to an embodiment of the present disclosure can be used as a constituent member of a display apparatus or an illumination apparatus. In addition, the organic light emitting device is applicable to the exposure light source of an electrophotographic image forming apparatus, the backlight of a liquid crystal display apparatus, a light emitting apparatus including a color filter in a white light source, and the like.

The display apparatus may be an image information processing apparatus that includes an image input unit for inputting image information from an area CCD, a linear CCD, a memory card, or the like, and an information processing unit for processing the input information, and displays the input image on a display unit.

In addition, a display unit included in an image capturing apparatus or an inkjet printer can have a touch panel function. The driving type of the touch panel function may be an infrared type, a capacitance type, a resistive film type, or an electromagnetic induction type, and is not particularly limited. The display apparatus may be used for the display unit of a multifunction printer.

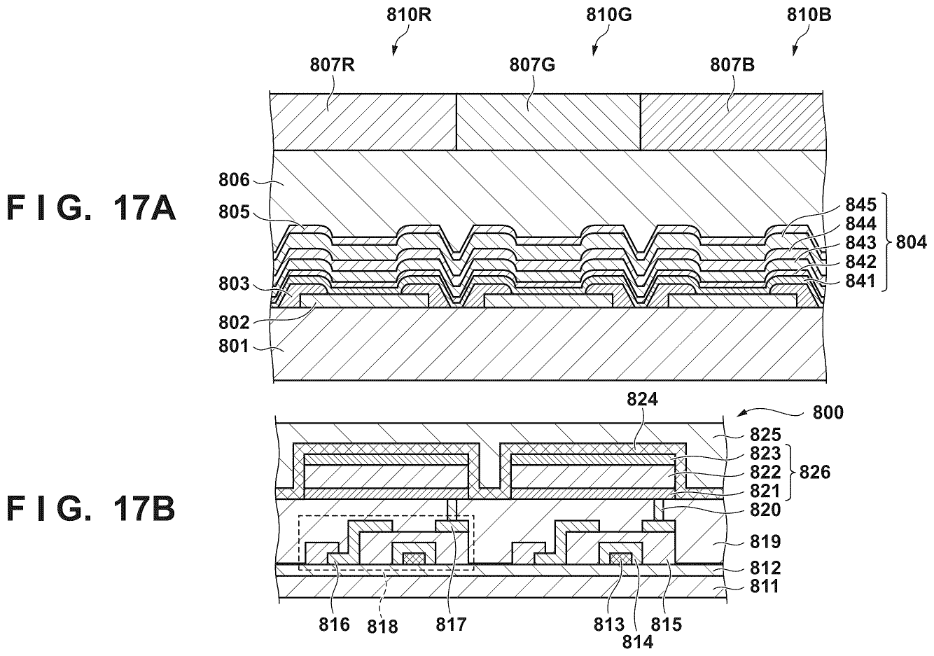

More details will be described next with reference to the accompanying drawings. FIG. 17A shows an example of a pixel PIX arranged in the light emitting apparatus 10 according to the above-described embodiment. The pixel includes sub-pixels 810 (pixels PIX). The sub-pixels are divided into sub-pixels 810R, 810G, and 810B by emitted light components. The light emission colors may be discriminated by the wavelengths of light components emitted from the light emitting layers, or light emitted from each sub-pixel may be selectively transmitted or undergo color conversion by a color filter or the like. Each sub-pixel includes a reflective electrode 802 as the first electrode on an interlayer insulating layer 801, an insulating layer 803 covering the end of the reflective electrode 802, an organic compound layer 804 covering the first electrode and the insulating layer, a transparent electrode 805 as the second electrode, a protection layer 806, and a color filter 807.

The interlayer insulating layer 801 can include a transistor and a capacitive device arranged in the interlayer insulating layer 801 or a layer below it. The transistor and the first electrode can electrically be connected via a contact hole (not shown) or the like.

The insulating layer 803 can also be called a bank or a pixel isolation film. The insulating layer 803 covers the end of the first electrode, and is arranged to surround the first electrode. A portion of the first electrode where no insulating layer 803 is arranged is in contact with the organic compound layer 804 to form a light emitting region.

The organic compound layer 804 includes a hole injection layer 841, a hole transport layer 842, a first light emitting layer 843, a second light emitting layer 844, and an electron transport layer 845.

The second electrode may be a transparent electrode, a reflective electrode, or a semi-transmissive electrode.

The protection layer 806 suppresses permeation of water into the organic compound layer. The protection layer is shown as a single layer but may include a plurality of layers. Each layer can be an inorganic compound layer or an organic compound layer.

The color filter 807 is divided into color filters 807R, 807G, and 807B by colors. The color filters can be formed on a planarizing film (not shown). A resin protection layer (not shown) may be arranged on the color filters. The color filters can be formed on the protection layer 806. Alternatively, the color filters can be provided on the counter substrate such as a glass substrate, and then the substrate may be bonded.

A display apparatus 800 (corresponding to the light emitting apparatus 10 according to the above-described embodiment) shown in FIG. 17B is provided with an organic light emitting device 826 and a TFT 818 as an example of a transistor. A substrate 811 of glass, silicon, or the like is provided and an insulating layer 812 is provided on the substrate 811. The active device such as the TFT 818 is arranged on the insulating layer, and a gate electrode 813, a gate insulating film 814, and a semiconductor layer 815 of the active device are arranged. The TFT 818 further includes the semiconductor layer 815, a drain electrode 816, and a source electrode 817. An insulating film 819 is provided on the TFT 818. The source electrode 817 and an anode 821 forming the organic light emitting device 826 are connected via a contact hole 820 formed in the insulating film.

A method of electrically connecting the electrodes (anode and cathode) included in the organic light emitting device 826 and the electrodes (source electrode and drain electrode) included in the TFT is not limited to that shown in FIG. 17B. That is, one of the anode and cathode and one of the source electrode and drain electrode of the TFT are electrically connected. The TFT indicates a thin-film transistor.

In the display apparatus 800 shown in FIG. 17B, an organic compound layer is illustrated as one layer. However, an organic compound layer 822 may include a plurality of layers. A first protection layer 824 and a second protection layer 825 are provided on a cathode 823 to suppress deterioration of the organic light emitting device.

A transistor is used as a switching device in the display apparatus 800 shown in FIG. 17B but may be used as another switching device.

The transistor used in the display apparatus 800 shown in FIG. 17B is not limited to a transistor using a single-crystal silicon wafer, and may be a thin-film transistor including an active layer on an insulating surface of a substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide. Note that a thin-film transistor is also called a TFT device.

The transistor included in the display apparatus 800 shown in FIG. 17B may be formed in the substrate such as a silicon substrate. Forming the transistor in the substrate means forming the transistor by processing the substrate such as a silicon substrate. That is, when the transistor is included in the substrate, it can be considered that the substrate and the transistor are formed integrally.

The light emission luminance of the organic light emitting device according to this embodiment can be controlled by the TFT which is an example of a switching device, and the plurality of organic light emitting devices can be provided in a plane to display an image with the light emission luminances of the respective devices. Here, the switching device according to this embodiment is not limited to the TFT, and may be a transistor formed from low-temperature polysilicon or an active matrix driver formed on the substrate such as a silicon substrate. The term “on the substrate” may mean “in the substrate”. Whether to provide a transistor in the substrate or use a TFT is selected based on the size of the display unit. For example, if the size is about 0.5 inch, the organic light emitting device is preferably provided on the silicon substrate.

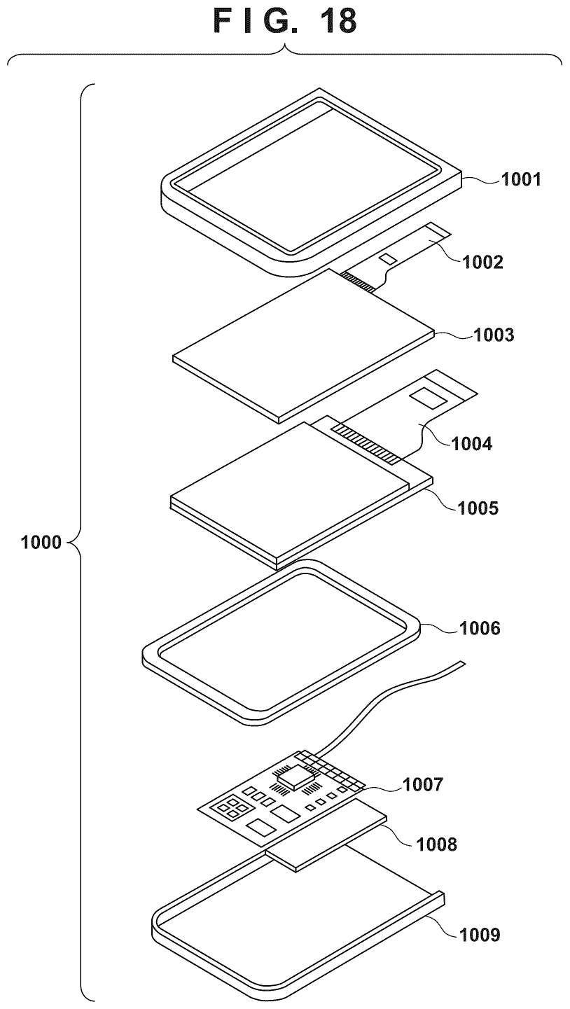

FIG. 18 is a schematic view showing an example of the display apparatus using the light emitting apparatus 10 according to the above-described embodiment. A display apparatus 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Active devices such as transistors are arranged on the circuit board 1007. The battery 1008 is unnecessary if the display apparatus 1000 is not a portable apparatus. Even when the display apparatus 1000 is a portable apparatus, the battery 1008 need not be provided at this position. The light emitting apparatus 10 according to the above-described embodiment can be applied to the display panel 1005. The pixels PIX arranged in the light emitting apparatus 10 functioning as the display panel 1005 operate in a state in which they are connected to the active devices such as transistors arranged on the circuit board 1007.

The display apparatus 1000 shown in FIG. 18 can be used for a display unit of a photoelectric conversion apparatus (also referred to as an image capturing apparatus) including an optical unit having a plurality of lenses, and an image sensor for receiving light having passed through the optical unit and photoelectrically converting the light into an electric signal. The photoelectric conversion apparatus can include a display unit for displaying information acquired by the image sensor. In addition, the display unit can be either a display unit exposed outside the photoelectric conversion apparatus, or a display unit arranged in the finder. The photoelectric conversion apparatus can be a digital camera or a digital video camera.

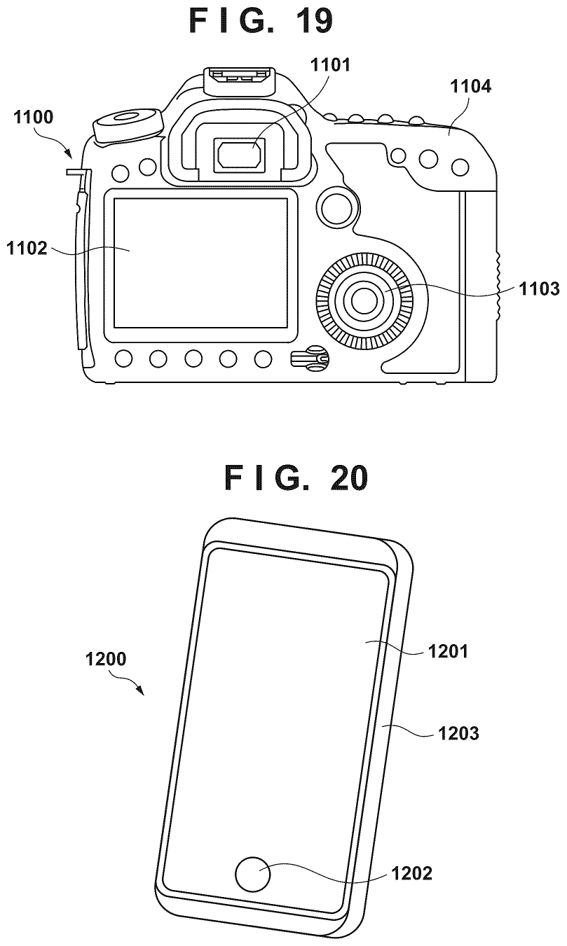

FIG. 19 is a schematic view showing an example of the photoelectric conversion apparatus using the light emitting apparatus 10 according to the above-described embodiment. A photoelectric conversion apparatus 1100 can include a viewfinder 1101, a rear display 1102, an operation unit 1103, and a housing 1104. The photoelectric conversion apparatus 1100 can also be called an image capturing apparatus. The light emitting apparatus 10 according to the above-described embodiment can be applied to the viewfinder 1101 or the rear display 1102 as a display unit. In this case, the light emitting apparatus 10 can display not only an image to be captured but also environment information, image capturing instructions, and the like. Examples of the environment information are the intensity and direction of external light, the moving velocity of an object, and the possibility that an object is covered with an obstacle.

The timing suitable for image capturing is a very short time in many cases, so the information is preferably displayed as soon as possible. Therefore, the light emitting apparatus 10 in which the pixel PIX including the light emitting device using the organic light emitting material such as an organic EL device is arranged may be used for the viewfinder 1101 or the rear display 1102. This is so because the organic light emitting material has a high response speed. The light emitting apparatus 10 using the organic light emitting material can be used for the apparatuses that require a high display speed more preferably than for the liquid crystal display apparatus.

The photoelectric conversion apparatus 1100 includes an optical unit (not shown). This optical unit has a plurality of lenses, and forms an image on a photoelectric conversion device (not shown) that receives light having passed through the optical unit and is accommodated in the housing 1104. The focal points of the plurality of lenses can be adjusted by adjusting the relative positions. This operation can also automatically be performed.

The light emitting apparatus 10 may be applied to a display unit of an electronic device. At this time, the display unit can have both a display function and an operation function. Examples of the portable terminal are a portable phone such as a smartphone, a tablet, and a head mounted display.

FIG. 20 is a schematic view showing an example of an electronic device using the light emitting apparatus 10 according to the above-described embodiment. An electronic device 1200 includes a display unit 1201, an operation unit 1202, and a housing 1203. The housing 1203 can accommodate a circuit, a printed board having this circuit, a battery, and a communication unit. The operation unit 1202 can be a button or a touch-panel-type reaction unit. The operation unit 1202 can also be a biometric authentication unit that performs unlocking or the like by authenticating the fingerprint. The portable apparatus including the communication unit can also be regarded as a communication apparatus. The light emitting apparatus 10 according to the above-described embodiment can be applied to the display unit 1201.

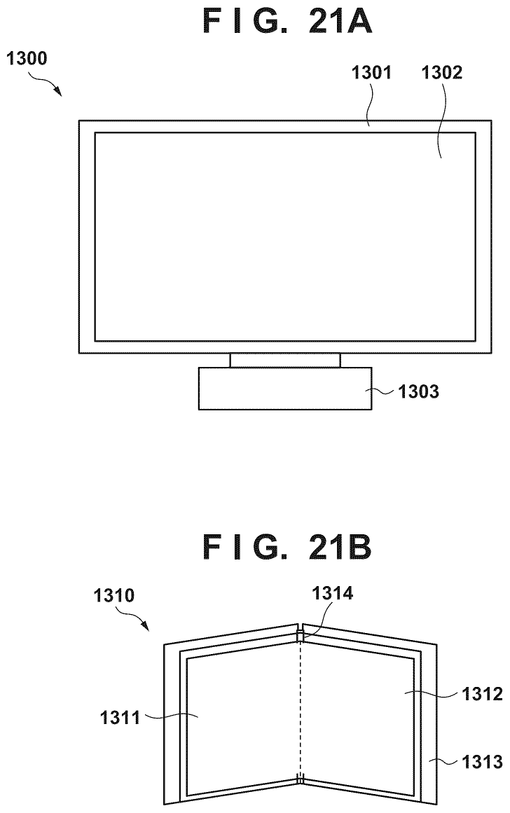

FIGS. 21A and 21B are schematic views showing examples of the display apparatus using the light emitting apparatus 10 according to the above-described embodiment. FIG. 21A shows a display apparatus such as a television monitor or a PC monitor. A display apparatus 1300 includes a frame 1301 and a display unit 1302. The light emitting apparatus 10 according to the above-described embodiment can be applied to the display unit 1302. The display apparatus 1300 can include a base 1303 that supports the frame 1301 and the display unit 1302. The base 1303 is not limited to the form shown in FIG. 21A. For example, the lower side of the frame 1301 may also function as the base 1303. In addition, the frame 1301 and the display unit 1302 can be bent. The radius of curvature in this case can be 5,000 mm (inclusive) to 6,000 mm (inclusive).

FIG. 21B is a schematic view showing another example of the display apparatus using the light emitting apparatus 10 according to the above-described embodiment. A display apparatus 1310 shown in FIG. 21B can be folded, and is a so-called foldable display apparatus. The display apparatus 1310 includes a first display unit 1311, a second display unit 1312, a housing 1313, and a bending point 1314. The light emitting apparatus 10 according to the above-described embodiment can be applied to each of the first display unit 1311 and the second display unit 1312. The first display unit 1311 and the second display unit 1312 can also be one seamless display apparatus. The first display unit 1311 and the second display unit 1312 can be divided by the bending point. The first display unit 1311 and the second display unit 1312 can display different images, and can also display one image together.

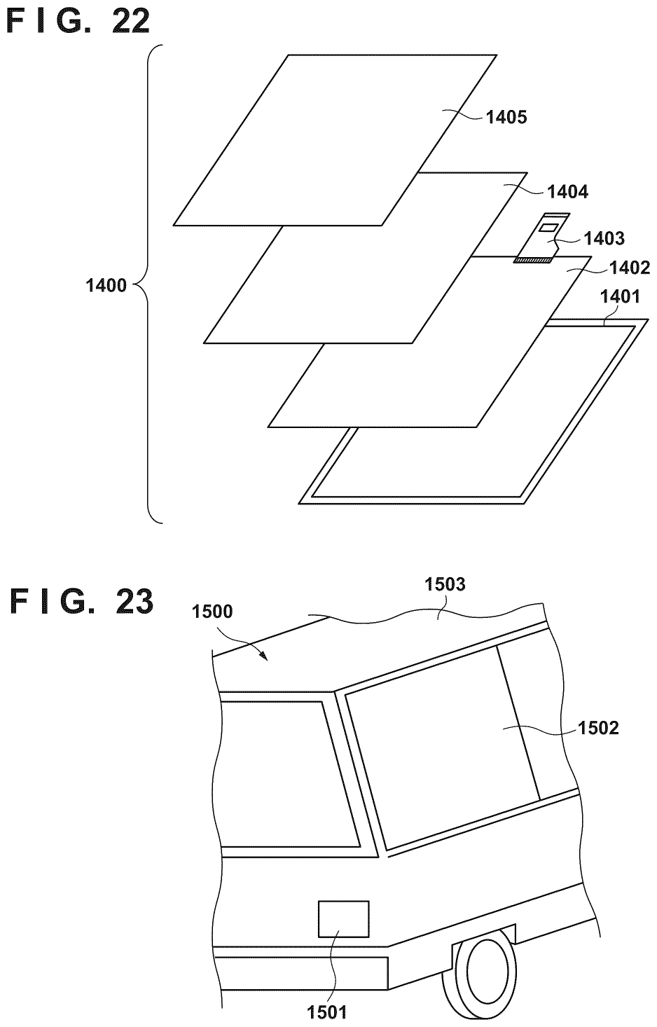

FIG. 22 is a schematic view showing an example of the illumination apparatus using the light emitting apparatus 10 according to the above-described embodiment. An illumination apparatus 1400 can include a housing 1401, a light source 1402, a circuit board 1403, an optical film 1404, and a light diffusing unit 1405. The light emitting apparatus 10 according to the above-described embodiment can be applied to the light source 1402. The optical film 1404 can be a filter that improves the color rendering of the light source. When performing lighting-up or the like, the light diffusing unit 1405 can throw the light of the light source over a broad range by effectively diffusing the light. The illumination apparatus can also include a cover on the outermost portion, as needed. The illumination apparatus 1400 can include both or one of the optical film 1404 and the light diffusing unit 1405.

The illumination apparatus 1400 is, for example, an apparatus for illuminating the interior of the room. The illumination apparatus 1400 can emit white light, natural white light, or light of any color from blue to red. The illumination apparatus 1400 can also include a light control circuit for controlling these light components. The illumination apparatus 1400 can also include a power supply circuit connected to the light emitting apparatus 10 functioning as the light source 1402. The power supply circuit is a circuit for converting an AC voltage into a DC voltage. White has a color temperature of 4,200 K, and natural white has a color temperature of 5,000 K. The illumination apparatus 1400 may also include a color filter. In addition, the illumination apparatus 1400 can include a heat radiation unit. The heat radiation unit radiates the internal heat of the apparatus to the outside of the apparatus, and examples are a metal having a high specific heat and liquid silicon.

FIG. 23 is a schematic view of an automobile having a taillight as an example of a vehicle lighting appliance using the light emitting apparatus 10 according to the above-described embodiment. An automobile 1500 has a taillight 1501, and can have a form in which the taillight 1501 is turned on when performing a braking operation or the like. The light emitting apparatus 10 according to the above-described embodiment can be used as a headlight serving as a vehicle lighting appliance. The automobile is an example of a moving body, and the moving body may be a ship, a drone, an aircraft, a railroad car, an industrial robot, or the like. The moving body may include a main body and a lighting appliance provided in the main body. The lighting appliance may be used to make a notification of the current position of the main body.

The light emitting apparatus 10 according to the above-described embodiment can be applied to the taillight 1501. The taillight 1501 can include a protection member for protecting the light emitting apparatus 10 functioning as the taillight 1501. The material of the protection member is not limited as long as the material is a transparent material with a strength that is high to some extent, and an example is polycarbonate. The protection member may be made of a material obtained by mixing a furandicarboxylic acid derivative, an acrylonitrile derivative, or the like in polycarbonate.

The automobile 1500 can include a vehicle body 1503, and a window 1502 attached to the vehicle body 1503. This window can be a window for checking the front and back of the automobile, and can also be a transparent display such as a head-up display. For this transparent display, the light emitting apparatus 10 according to the above-described embodiment may be used. In this case, the constituent materials of the electrodes and the like of the light emitting apparatus 10 are formed by transparent members.

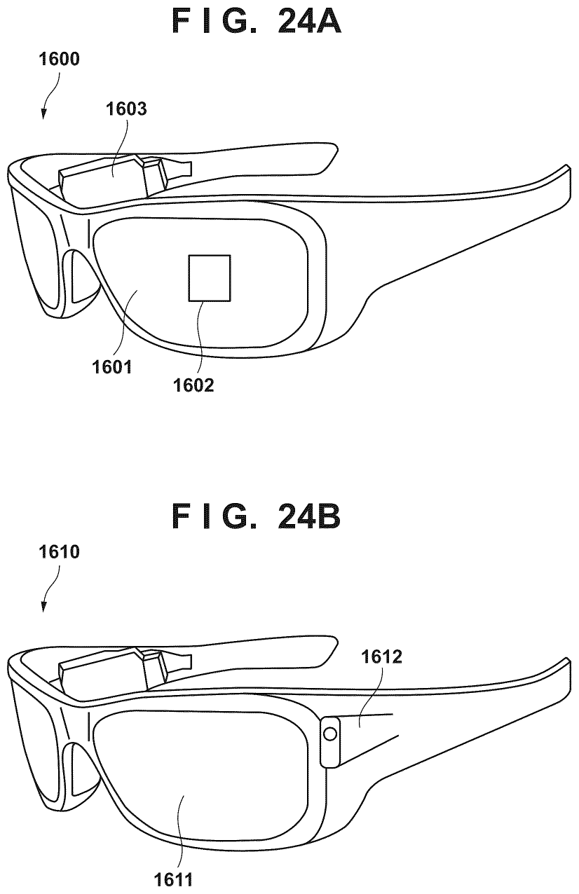

Further application examples of the light emitting apparatus 10 according to the above-described embodiment will be described with reference to FIGS. 24A and 24B. The light emitting apparatus 10 can be applied to a system that can be worn as a wearable device such as smartglasses, a Head Mounted Display (HMD), or a smart contact lens. An image capturing display apparatus used for such application examples includes an image capturing apparatus capable of photoelectrically converting visible light and a light emitting apparatus capable of emitting visible light.

Glasses 1600 (smartglasses) according to one application example will be described with reference to FIG. 24A. An image capturing apparatus 1602 such as a CMOS sensor or an SPAD is provided on the surface side of a lens 1601 of the glasses 1600. In addition, the light emitting apparatus 10 according to the above-described embodiment is provided on the back surface side of the lens 1601.

The glasses 1600 further include a control apparatus 1603. The control apparatus 1603 functions as a power supply that supplies electric power to the image capturing apparatus 1602 and the light emitting apparatus 10 according to each embodiment. In addition, the control apparatus 1603 controls the operations of the image capturing apparatus 1602 and the light emitting apparatus 10. An optical system configured to condense light to the image capturing apparatus 1602 is formed on the lens 1601.

Glasses 1610 (smartglasses) according to one application example will be described with reference to FIG. 24B. The glasses 1610 include a control apparatus 1612, and an image capturing apparatus corresponding to the image capturing apparatus 1602 and the light emitting apparatus 10 are mounted on the control apparatus 1612. The image capturing apparatus in the control apparatus 1612 and an optical system configured to project light emitted from the light emitting apparatus 10 are formed in a lens 1611, and an image is projected to the lens 1611. The control apparatus 1612 functions as a power supply that supplies electric power to the image capturing apparatus and the light emitting apparatus 10, and controls the operations of the image capturing apparatus and the light emitting apparatus 10. The control apparatus 1612 may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light receiving device detects reflected light of the emitted infrared rays from the eyeball, thereby obtaining a captured image of the eyeball. A reduction unit for reducing light from the infrared ray emitting unit to the display unit in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The light emitting apparatus 10 according to the embodiment of the present disclosure can include an image capturing apparatus including a light receiving device, and control a displayed image based on the line-of-sight information of the user from the image capturing apparatus.

More specifically, the light emitting apparatus 10 decides a first visual field region at which the user is gazing and a second visual field region other than the first visual field region based on the line-of-sight information. The first visual field region and the second visual field region may be decided by the control apparatus of the light emitting apparatus 10, or those decided by an external control apparatus may be received. In the display region of the light emitting apparatus 10, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority is decided from the first display region and the second display region based on line-of-sight information. The first display region and the second display region may be decided by the control apparatus of the light emitting apparatus 10, or those decided by an external control apparatus may be received. The resolution of the region of higher priority may be controlled to be higher than the resolution of the region other than the region of higher priority. That is, the resolution of the region of relatively low priority may be low.

Note that AI may be used to decide the first visual field region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the light emitting apparatus 10, the image capturing apparatus, or an external apparatus. If the external apparatus holds the AI program, it is transmitted to the light emitting apparatus 10 via communication.

When performing display control based on line-of-sight detection, smartglasses further including an image capturing apparatus configured to capture the outside can be applied. The smartglasses can display captured outside information in real time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-021450 filed on Feb. 15, 2024, which is hereby incorporated by reference herein in its entirety.

What is claimed is:

1. A light emitting apparatus comprising:
a plurality of light emitting devices;
a plurality of conversion circuits provided in correspondence with the plurality of light emitting devices, respectively; and
a voltage generator configured to generate a plurality of reference voltages,
wherein each of the plurality of conversion circuits converts, using the plurality of reference voltages generated by the voltage generator, a digital signal supplied from an outside into an analog signal for driving one corresponding light emitting device of the plurality of light emitting devices,
at least one reference voltage of the plurality of reference voltages is supplied from the voltage generator to each of the plurality of conversion circuits via a buffer circuit,
the plurality of conversion circuits include a first group of conversion circuits to which the at least one reference voltage is supplied via a first buffer circuit, and a second group of conversion circuits to which the at least one reference voltage is supplied via a second buffer circuit, and
the first buffer circuit and the second buffer circuit are connected in series, and an output of the first buffer circuit is input to the second buffer circuit.

2. The apparatus according to claim 1, wherein the plurality of conversion circuits include not less than two conversion circuits to which the at least one reference voltage is supplied via a common buffer circuit.

3. The apparatus according to claim 1, wherein
the plurality of reference voltages generated by the voltage generator include a first reference voltage and a second reference voltage, and
for the first reference voltage, a common buffer circuit is provided for every first number of conversion circuits, and for the second reference voltage, a common buffer circuit is provided for every second number of conversion circuits different from the first number.

4. The apparatus according to claim 1, wherein the plurality of conversion circuits include not less than two conversion circuits to which the at least one reference voltage is supplied via different buffer circuits.

5. The apparatus according to claim 1, wherein the first buffer circuit is constituted by a source follower formed by a MOS transistor and a current source, and the second buffer circuit is constituted by a unity gain buffer formed by a differential amplification circuit.

6. The apparatus according to claim 1, wherein an area of the first buffer circuit is larger than an area of the second buffer circuit.

7. The apparatus according to claim 1, wherein noise of the first buffer circuit is smaller than noise of the second buffer circuit.

8. The apparatus according to claim 1, wherein
the at least one reference voltage is supplied to the first group of conversion circuits further via a third buffer circuit,
the at least one reference voltage is supplied to the second group of conversion circuits further via a fourth buffer circuit, and
the third buffer circuit and the fourth buffer circuit are connected in parallel.

9. The apparatus according to claim 1, wherein the plurality of conversion circuits include the first group of conversion circuits to which the at least one reference voltage is supplied via a third buffer circuit, and the second group of conversion circuits to which the at least one reference voltage is supplied via a fourth buffer circuit, and
the third buffer circuit and the fourth buffer circuit are connected in parallel.

10. The apparatus according to claim 1, wherein
the voltage generator generates the plurality of reference voltages by a resistor string connected between two terminals, and
a voltage is applied to each of the two terminals via a buffer circuit.

11. The apparatus according to claim 1, wherein
the plurality of reference voltages generated by the voltage generator include a first reference voltage and a second reference voltage,
the light emitting apparatus further comprises a second resistor string connected between an output terminal of the first reference voltage and an output terminal of the second reference voltage in the voltage generator,
each of the first reference voltage and the second reference voltage is input to the second resistor string via a buffer circuit, and
a plurality of voltages generated by the second resistor string are supplied to each of the plurality of conversion circuits.

12. The apparatus according to claim 11, wherein
the plurality of conversion circuits include the first group of conversion circuits and the second group of conversion circuits, and
the second resistor string is provided for each of the first group of conversion circuits and the second group of conversion circuits.

13. The apparatus according to claim 1, wherein
the plurality of conversion circuits include the first group of conversion circuits and the second group of conversion circuits, and
the voltage generator is provided for each of the first group of conversion circuits and the second group of conversion circuits.

14. The apparatus according to claim 1, wherein each of the plurality of conversion circuits includes a holding circuit configured to temporarily hold the at least one reference voltage supplied from the voltage generator, and after the holding circuit holds the at least one reference voltage, converts the digital signal into the analog signal using the at least one reference voltage held in the holding circuit.

15. The apparatus according to claim 14, wherein an operation of the buffer circuit is stopped during a period in which the at least one reference voltage is held in the holding circuit.

16. The apparatus according to claim 1, wherein a plurality of buffer circuits provided for one reference voltage of the plurality of reference voltages use the same power supply, and buffer circuits provided for one reference voltage of the plurality of reference voltages and buffer circuits provided for other reference voltages use different power supplies.

17. The apparatus according to claim 1, further comprising a first detector configured to detect an emission luminance in each of the plurality of light emitting devices, and a controller configured to control the buffer circuit,
wherein the buffer circuit includes an output offset adjustment mechanism, and
wherein the controller controls an output of the buffer circuit by the output offset adjustment mechanism, based on a detection result of the first detector, such that the emission luminance in each of the plurality of light emitting devices is corrected.

18. The apparatus according to claim 1, further comprising a plurality of buffer circuits provided for the plurality of reference voltages, respectively, a second detector configured to detect an output offset value between the plurality of buffer circuits, and a controller configured to control the plurality of buffer circuits,
wherein each of the plurality of buffer circuits includes an output offset adjustment mechanism, and
wherein the controller controls an output of each buffer circuit by the output offset adjustment mechanism, based on a detection result of the second detector, such that the output offset value between the plurality of buffer circuits is corrected.

19. The apparatus according to claim 1, wherein
the light emitting apparatus comprises:
the plurality of light emitting devices;
the plurality of conversion circuits provided in correspondence with the plurality of light emitting devices, respectively; and
the voltage generator configured to generate plurality of reference voltages,
each of the plurality of conversion circuits converts, using the plurality of reference voltages generated by the voltage generator, the digital signal supplied from the outside into the analog signal for driving one corresponding light emitting device of the plurality of light emitting devices,
the at least one reference voltage of the plurality of reference voltages is supplied from the voltage generator to each of the plurality of conversion circuits via the buffer circuit,
the plurality of reference voltages generated by the voltage generator include a first reference voltage and a second reference voltage, and
for the first reference voltage, a common buffer circuit is provided for every first number of conversion circuits, and for the second reference voltage, a common buffer circuit is provided for every second number of conversion circuits different from the first number.

20. The apparatus according to claim 1, wherein
the light emitting apparatus comprises:
the plurality of light emitting devices;
the plurality of conversion circuits provided in correspondence with the plurality of light emitting devices, respectively; and
the voltage generator configured to generate plurality of reference voltages,
each of the plurality of conversion circuits converts, using the plurality of reference voltages generated by the voltage generator, the digital signal supplied from the outside into the analog signal for driving one corresponding light emitting device of the plurality of light emitting devices,
the at least one reference voltage of the plurality of reference voltages is supplied from the voltage generator to each of the plurality of conversion circuits via the buffer circuit, and
the plurality of conversion circuits include not less than two conversion circuits to which the at least one reference voltage is supplied via different buffer circuits.

21. A wearable device including a display apparatus configured to display an image, wherein the display apparatus includes a light emitting apparatus defined in claim 1.

22. A display apparatus including a light emitting apparatus defined in claim 1, and an active device connected to the light emitting apparatus.
